(19) United States
(12) Patent Application Publication
(10) Pub. No.: US 2018/0220368 A1
(43) Pub. Date: Aug. 2, 2018

(54) CHANGING BASIC SERVICE SET (BSS) COLOR IN DUAL BEACON OPERATION

(71) Applicant: QUALCOMM Incorporated, San Diego, CA (US)

(72) Inventors: Ravi GIDVANI, Fremont, CA (US); Abhishek Pramod PATIL, San Diego, CA (US); Alireza RAISSINIA, Monte Sereno, CA (US); Alfred ASTERJADHI, San Diego, CA (US); George CHERIAN, San Diego, CA (US)

(21) Appl. No.: 15/873,266

(22) Filed: Jan. 17, 2018

Related U.S. Application Data
(60) Provisional application No. 62/453,768, filed on Feb. 2, 2017.

(51) Int. Cl. H04W 52/02; H04W 74/08; H04W 76/12; H04W 80/02

(52) U.S. Cl. CPC H04W 52/0216; H04W 74/0816; H04W 84/12; H04W 80/02; H04W 76/12

(57) ABSTRACT

This disclosure provides systems, methods, and apparatuses for implementing changes to Basic Service Set (BSS) parameters of an access point (AP) in a synchronized manner across multiple physical layer (PHY) formats. In some implementations, an AP may enable STAs that use different PHY formats to implement the changes at substantially the same time. For example, the change in BSS may be aligned with a target beacon transmission time (TBTT) of a first PHY format, and the AP may broadcast information, in a second PHY format, pointing to the TBTT of the first PHY format. In some other implementations, the AP may enable the STAs to implement the changes at different times. For example, STAs using a first PHY format may implement the change at a TBTT of the first PHY format, whereas STAs using a second PHY format may implement the change at a TBTT of the second PHY format.

### CROSS-REFERENCE TO RELATED APPLICATIONS

This patent application claims priority to U.S. Provisional Patent Application No. 62/453,768 entitled “CHANGING BSS COLOR IN DUAL BEACON OPERATION” filed on Feb. 2, 2017 and assigned to the assignee hereof. The disclosure of the prior application is considered part of and is incorporated by reference in this patent application.

### TECHNICAL FIELD

The present implementations relate generally to wireless networks, and specifically to changing the BSS color of an AP that supports multiple PHY formats.

### DESCRIPTION OF THE RELATED TECHNOLOGY

A wireless local area network (WLAN) may be formed by one or more access points (APs) that provide a shared wireless communication medium for use by a number of client devices or stations (STAs). Each AP, which may correspond to a Basic Service Set (BSS), periodically broadcasts beacon frames to enable any STAs within wireless range of the AP to establish and maintain a communication link with the WLAN. As a STA moves through a given environment, the quality of communications with an associated AP may fluctuate. For example, the perceived signal quality of the WLAN may degrade as the STA moves further away from the associated AP. This may result in reduced throughput or termination of the communication link.

In some configurations, an AP may communicate with one or more STAs using multiple frame formats. For example, the IEEE 802.11ax specification describes an “extended range” (ER) frame format that allows the AP to communicate with STAs over an extended range (such as beyond a standard or conventional wireless range of the AP). The IEEE 802.11ax specification also describes a BSS color indicator that may be used to differentiate BSSs in dense deployment scenarios (such as when multiple BSSs “overlap” with one another). However, there may be instances where multiple APs (such as those associated with different BSSs) select the same BSS color. This may cause one or more of the APs to change their respective BSS colors.

A high efficiency (HE) AP operating in a dual beacon configuration may periodically broadcast beacons in both a legacy format (referred to as “legacy beacons”) and an ER format (referred to as “ER beacons”). However, the HE AP typically broadcasts legacy beacons at different intervals than ER beacons. For example, legacy beacons and ER beacons may have different target beacon transmission times (TBTTs). The discrepancy in timing between the different frame formats presents a challenge when implementing a change to one or more BSS parameters of the AP (such as switching to a new wireless channel or a new BSS color), since changes in BSS are typically implemented at the same time (coinciding with a single TBTT) by all devices associated with the BSS.

### SUMMARY

The systems, methods and devices of this disclosure each have several innovative aspects, no single one of which is solely responsible for the desirable attributes disclosed herein.

One innovative aspect of the subject matter of this disclosure can be implemented in a method of implementing changes to Basic Service Set (BSS) parameters of an access point (AP). The method may include steps of transmitting a first management frame indicating a change to a BSS parameter of the AP, wherein the first management frame is formatted in accordance with a first PHY format, transmitting a second management frame indicating the change to the BSS parameter, wherein the second management frame is formatted in accordance with a second PHY format, and implementing the change to the BSS parameter at a target transition time based at least in part on a timing of beacon frames broadcast by the AP in accordance with each of the first and second PHY formats. For example, one of the first or second PHY formats may be an extended range (ER) format.

Each of the first and second management frames may include information indicating the target transition time. In some implementations, the target transition time may coincide with a target beacon transmission time (TBTT) associated with the first PHY format. In some aspects, the information in the second management frame may indicate a timing offset between the target transition time and a TBTT associated with the second PHY format. In some other aspects, the information in the second management frame may indicate a timing of TBTTs associated with the first PHY format.

In some other implementations, the target transition time may overlap a first TBTT associated with the first PHY format and a second TBTT associated with the second PHY format. In some aspects, the information in the first management frame may indicate the first TBTT as the target transition time and the information in the second management frame may indicate the second TBTT as the target transition time. In some other aspects, the information in the first management frame may include a countdown to the first TBTT and the information in the second management frame may include a countdown to the second TBTT.

The BSS parameter may include a BSS color. In some implementations, the step of implementing the change to the BSS parameter at the target transition time may further include steps of disabling a BSS color check procedure for a period of time prior to the target transition time, implementing the change in BSS color during the period of time for which the BSS color check procedure is disabled, and re-enabling the BSS color check procedure after the change in BSS color has been implemented.

In some implementations, the first management frame may be transmitted on behalf of a first BSS associated with the AP and the second management frame may be transmitted on behalf of a second BSS associated with the AP. The BSS parameter may be shared by the first BSS and the second BSS. In some implementations, at least one of the first or second management frames may include a neighbor report identifying the first and second BSSs as co-located BSSs.

Another innovative aspect of the subject matter described in this disclosure can be implemented in a wireless device (such as an AP). The wireless device includes one or more processors and a memory storing instructions that, when executed by the one or more processors, cause the wireless device to transmit a first management frame indicating a change to a BSS parameter of the wireless device, wherein the first management frame is formatted in accordance with a first PHY format, transmit a second management frame indicating the change to the BSS parameter, wherein the second management frame is formatted in accordance with a second PHY format, and implement the change to the BSS parameter at a target transition time based at least in part on a timing of beacon frames broadcast by the wireless device in accordance with each of the first and second PHY formats.

Each of the first and second management frames may include information indicating the target transition time. In some implementations, the target transition time may coincide with a target beacon transmission time (TBTT) associated with the first PHY format. In some aspects, the information in the second management frame may indicate a timing offset between the target transition time and a TBTT associated with the second PHY format. In some other aspects, the information in the second management frame may indicate a timing of TBTTs associated with the first PHY format.

In some other implementations, the target transition time may overlap a first TBTT associated with the first PHY format and a second TBTT associated with the second PHY format. In some aspects, the information in the first management frame may indicate the first TBTT as the target transition time and the information in the second management frame may indicate the second TBTT as the target transition time. In some other aspects, the information in the first management frame may include a countdown to the first TBTT and the information in the second management frame may include a countdown to the second TBTT.

The BSS parameters may include a BSS color. In some implementations, execution of the instructions for implementing the change to the BSS parameter at the target transition time may further cause the wireless device to disable a BSS color check procedure for a period of time prior to the target transition time, implement the change in BSS color during the period of time for which the BSS color check procedure is disabled, and re-enable the BSS color check procedure after the change in BSS color has been implemented.

In some implementations, the first management frame may be transmitted on behalf of a first BSS associated with the wireless device and the second management frame may be transmitted on behalf of a second BSS associated with the wireless device. The BSS parameter may be shared by the first BSS and the second BSS.

Another innovative aspect of the subject matter described in this disclosure can be implemented in a method of implementing changes to BSS parameters of a wireless station (STA). The method may include steps of receiving a management frame from an AP, wherein the management frame is formatted in accordance with a first PHY format, detecting a change to a BSS parameter of the AP based on the received management frame, and implementing the change to the BSS parameter at a target transition time based at least in part on a timing of beacon frames broadcast by the AP in accordance with a second PHY format.

In some implementations, the target transition time may coincide with a TBTT associated with the second PHY format. In some aspects, the received management frame may indicate a timing offset between the target transition time and a TBTT associated with the first PHY format. In some other aspects, the received management frame may indicate a timing of TBTTs associated with the second PHY format.

In some other implementations, the target transition time may overlap a first TBTT associated with the first PHY format and a second TBTT associated with the second PHY format. In some aspects, the received management frame may indicate the first TBTT as the target transition time. In some other aspects, the received management frame may include a countdown to the first TBTT.

Another innovative aspect of the subject matter described in this disclosure can be implemented in a wireless device (such as a STA). The wireless device includes one or more processors and a memory storing instructions that, when executed by the one or more processors, cause the wireless device to receive a management frame from an AP, wherein the management frame is formatted in accordance with a first PHY format, detect a change to a BSS parameter of the AP based on the received management frame, and implement the change to the BSS parameter at a target transition time based at least in part on a timing of beacon frames broadcast by the AP in accordance with a second PHY format.

In some implementations, the target transition time may coincide with a TBTT associated with the second PHY format. In some aspects, the received management frame may indicate a timing offset between the target transition time and a TBTT associated with the first PHY format. In some other aspects, the received management frame may indicate a timing of TBTTs associated with the second PHY format.

In some other implementations, the target transition time may overlap a first TBTT associated with the first PHY format and a second TBTT associated with the second PHY format. In some aspects, the received management frame may indicate the first TBTT as the target transition time. In some other aspects, the received management frame may include a countdown to the first TBTT.

### BRIEF DESCRIPTION OF THE DRAWINGS

FIG. 1 shows a block diagram of a wireless system.

FIG. 2 shows an example HE Operation element.

FIG. 3 shows an example wireless system capable of supporting multiple. PHY formats.

FIG. 4 shows a timing diagram depicting an example operation for changing a BSS parameter of an AP that supports multiple PHY formats.

FIG. 5 shows an example BSS color change announcement element.

FIG. 6 shows a timing diagram depicting an example operation for changing the BSS color of an AP that supports multiple PHY formats.

FIGS. 7A and 7B show example wireless systems capable of supporting multiple PHY formats.

FIG. 8 shows a block diagram of an example access point.

FIG. 9 shows a block diagram of an example wireless station.

FIG. 10 shows a flowchart depicting an example operation for changing a BSS parameter of an AP that supports multiple PHY formats.

FIG. 11 shows a flowchart depicting an example operation for changing the BSS color of an AP that supports multiple PHY formats.

FIG. 12 shows a flowchart depicting an example operation for implementing a change to a BSS parameter of an AP that supports multiple PHY formats.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM or General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

An AP may be capable of communicating with a STA using multiple PHY formats. For example, the IEEE 802.11ax specification describes an extended range (ER) format that allows a high efficiency (HE) access point (AP) to communicate with stations (STAs) over an extended range (such as beyond a standard or conventional wireless range of the AP). An HE AP operating in a dual beacon configuration may periodically broadcast beacons in a non-ER (or legacy) format at first target beacon transmission times (TBTTs), and may periodically broadcast beacons in the ER format at second TBTTs. However, none of the second TBTTs may coincide with any of the first TBTTs. The discrepancy in timing between the different frame formats presents a challenge when implementing a change to one or more BSS parameters of the AP (such as switching to a new wireless channel or a new BSS color), since changes in BSS are typically implemented at the same time (coinciding with a single TBTT) by all devices associated with the BSS. Thus, the implementations described herein may enable an HE AP to make changes to one or more BSS parameters in a synchronized manner across multiple PHY formats.

In some implementations, an HE AP may enable STAs operating in accordance with different PHY formats to implement changes to a BSS parameter at substantially the same time. For example, the change in BSS may be aligned with a TBTT of a first PHY format. The AP may thus broadcast information, in a second PHY format, pointing to the TBTT of the first PHY format. In some other implementations, an HE AP may enable STAs operating in accordance with different PHY formats to implement changes to the BSS parameter at different times. For example, a first set of STAs (using a first PHY format) may implement the change at a TBTT of the first PHY format and a second set of STAs (using a second PHY format) may implement the change in BSS at a TBTT of the second PHY format. To ensure continuity of communications between the AP and its associated STAs, while each of the STAs implements the change in BSS, the AP may temporarily disable functionality related to the BSS feature(s) being changed.

Particular implementations of the subject matter described in this disclosure can be implemented to realize one or more of the following potential advantages. The implementations may improve the performance of wireless devices configured for multiple PHY formats. For example, by providing information in a first PHY format about TBTTs of a second PHY format, an HE AP may enable STAs operating in accordance with different PHY formats to implement changes to the BSS in a synchronized fashion. This may allow the AP to dynamically change one or more of its BSS parameters (such as switching to a new wireless channel or a new BSS color) in response to changes or interference in the wireless environment. Furthermore, by temporarily disabling certain BSS features, an HE AP may enable STAs operating in accordance with different PHY formats to implement the changes to the BSS parameters according to their respective TBTTs. This may reduce the overhead required to signal and process changes to the BSS parameters.

In the following description, numerous specific details are set forth such as examples of specific components, circuits, and processes to provide a thorough understanding of the present disclosure. The term “HE” may refer to a high efficiency frame format or protocol that may provide improved signaling capabilities over previous (“legacy”) protocols. Thus, the term “HE STA” may refer to a STA that is capable of implementing one or more HE frame formats or protocols. Similarly, the term “HE AP” may refer to an AP that is capable of implementing one or more HE frame formats or protocols. The IEEE 802.11ax specification defines a set of HE protocols that include, for example, an extended range (ER) frame format that may be used to extend the wireless range of HE-capable devices. Thus, the term “ER frame” may refer to a communication frame that is formatted for communications over greater distances (such as beyond a standard or conventional range of wireless communications provided by legacy IEEE 802.11 protocols). Similarly, the term “non-ER frame” may refer to a communication frame that is formatted in any of the various other HE or legacy frame formats (which does not include the ER format).

The term “PHY format” may refer to a particular formatting of a communication frame that is implemented in the physical layer (PHY). Thus, the terms “PHY format” and “frame format” may be used herein interchangeably. For example, ER frames and non-ER frames may have different PHY formats. More specifically, an ER frame may be formatted differently than a non-ER frame at the PHY layer of a transmitting device. Similarly, an ER frame may be interpreted differently than a non-ER frame at the PHY layer of a receiving device. In addition, although described herein in terms of exchanging data frames between wireless devices, the implementations may be applied to the exchange of any data unit, packet, or frame between wireless devices. Thus, the term “frame” may include any frame, packet, or data unit such as, for example, protocol data units (PDUs), MAC protocol data units (MPDUs), aggregated MPDUs (A-MPDUs), and physical layer convergence procedure protocol data units (PPDUs).

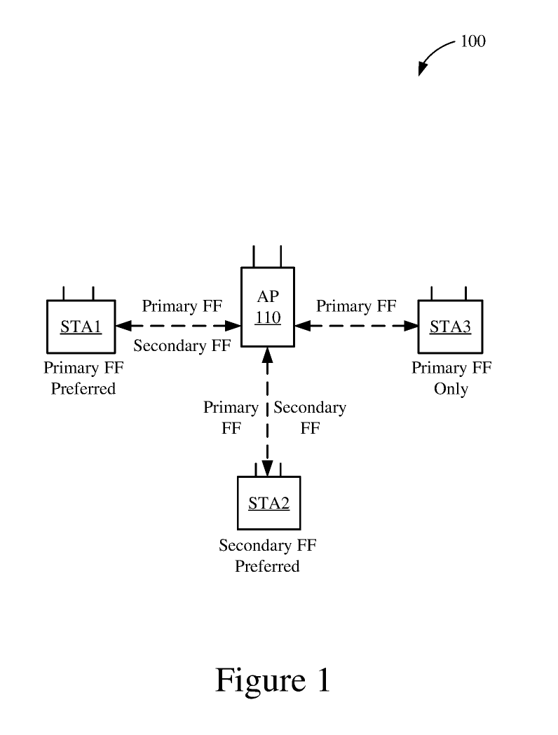

FIG. 1 shows a block diagram of a wireless system 100. The wireless system 100 is shown to include an access point (AP) 110 and a number of wireless stations STA1-STA3. Although three wireless station STA1-STA3 are shown in the example of FIG. 1 for simplicity, it is to be understood that the wireless system 100 may include any number of STAs.

The wireless stations STA1-STA3 may include any suitable Wi-Fi enabled wireless device including, for example, a cell phone, personal digital assistant (PDA), tablet device, laptop computer, or the like. The AP 110 may be any suitable device that allows one or more wireless devices to connect to a network (such as a local area network (LAN), wide area network (WAN), metropolitan area network (MAN), or the Internet) using Wi-Fi, Bluetooth, or any other suitable wireless communication standards. In some implementations, the AP 110 may be any suitable wireless device (such as a wireless STA) acting as a software-enabled access point (“SoftAP”). The AP 110 and stations STA1-STA3 may each include one or more transceivers, one or more processing resources (such as processors or ASICs), one or more memory resources, and a power source.

In some implementations, the AP 110 may be capable of implementing multiple frame formats. Specifically, the AP 110 may be configured to format outgoing communication frames in accordance with a primary frame format (FF) and a secondary frame format. The primary frame format may perform better than the secondary frame format in certain environments or channel conditions, whereas the secondary frame format may perform better than the primary frame format in other environments or channel conditions. For example, in some implementations, the primary frame format may be generally associated with a higher signaling rate than the secondary frame format. On the other hand, the lower signaling rate of the secondary frame format may enable the secondary frame format to be used for communications over greater distances than the primary frame format.

The stations STA1 and STA2 may be capable of receiving communication frames in either of the primary or secondary frame formats. Based on channel conditions or a proximity of the AP 110 to STA1, communication frames transmitted by the AP 110 to STA1 may perform better when formatted in accordance with the primary frame format (as opposed to the secondary frame format). In other words, STA1 may “prefer” the primary frame format to the secondary frame format. On the other hand, based on channel conditions or a proximity of the AP 110 to STA2, communication frames transmitted by the AP 110 to STA2 may perform better when formatted in accordance with the secondary frame format. Accordingly, STA2 may prefer the secondary frame format to the primary PHY format.

Although the AP 110 and each of the stations STA1 and STA2 is capable of implementing multiple frame formats, STA3 may be capable of receiving communication frames solely in the primary frame format. To ensure support for each of the stations STA1-STA3, the AP 110 may transmit communication frames in each of the primary frame format and the secondary frame format. In some implementations, the AP 110 may transmit the same information, to one or more of the stations STA1-STA3, using a communication frame formatted in accordance with the primary frame format, and again using a communication frame formatted in accordance with the secondary frame format. For example, the AP 110 may broadcast beacon frames in the primary frame format at “primary” target beacon transmission times (TBTTs), and may further broadcast beacon frames in the secondary frame format at “secondary” TBTTs. In some implementations, the primary TBTTs may be different than (or offset relative to) the secondary TBTTs. For example, none of the primary TBTTs may be aligned (or coincide) with any of the secondary TBTTs.

In some implementations, the AP 110 may dynamically change one or more of its settings or operating parameters (BSS parameters). For example, the AP 110 may switch to a new wireless channel if it detects too much interference on its current channel. As another example, the AP 110 may change its BSS color if it detects another AP in the vicinity with the same BSS color. To provide uninterrupted service when implementing a change to one or more BSS parameters, the AP 110 may notify each of its associated STAs of the new BSS parameters and a time at which such changes are expected to occur. However, because different STAs may operate in accordance with different frame formats, the AP 110 may signal a “change in BSS” to each of the stations STA1-STA3 in accordance with each of the primary and secondary frame formats. In some implementations, the AP 110 may advertise or otherwise signal the change in BSS by broadcasting respective beacon frames, in each of the primary and secondary frame formats, carrying information indicating the change to one or more BSS parameters (such as a change in wireless channel or BSS color) and the time at which the change is scheduled to occur (such as a target transition time).

In some aspects, each of the devices in the wireless system 100 (including the AP 110 and stations STA1-STA3) may implement the change in BSS at substantially the same time. For example, the change in BSS may coincide with one of the primary TBTTs or one of the secondary TBTTs. To ensure continuity of service within a particular BSS, it may be desirable for all devices (including APs and STAs) associated with the BSS to implement any changes to the BSS at substantially the same time. However, STAs operating in accordance with the primary frame format may be unaware of the timing of the secondary TBTTs, and STAs operating in accordance with the secondary frame format may be unaware of the timing of the primary TBTTs. Thus, in some implementations, the AP 110 may select a target transition time that coincides with a TBTT of a particular frame format (such as the primary frame format), and may provide information in another frame format (such as the secondary frame format) pointing to the selected TBTT (or the target transition time). In some other implementations, the target transition time may not coincide with a particular TBTT.

For example, the AP 110 may signal the change in BSS by transmitting a first frame (or beacon) in accordance with the primary frame format and a second frame (or beacon) in accordance with the secondary frame format. The first frame may indicate the type of change to occur (such as a change in wireless channel or BSS color) and the time at which the change is to occur (such as an absolute time or a subsequent number of primary TBTT intervals). If the change in BSS coincides with one of the secondary TBTTs, the first frame may further include information pointing to the secondary TBTTs (such as a timing of the next secondary TBTT or a relative offset between the primary TBTTs and secondary TBTTs). The second frame may indicate the type of change to occur (such as a change in wireless channel or BSS color) and the time at which the change is to occur (such as an absolute time or a subsequent number of primary TBTT intervals). If the change in BSS coincides with one of the primary TBTTs, the second frame may further include information pointing to the primary TBTTs (such as a timing of the next primary TBTT or a relative offset between primary TBTTs and secondary TBTTs).

In some other implementations, the AP 110 may temporarily disable certain BSS features (associated with the BSS parameter to be changed) to allow STAs operating in accordance with different frame formats to implement the change in BSS according to their respective TBTTs. For example, if the change in BSS corresponds to a change in BSS color, the AP 110 may temporarily disable a “BSS color check” procedure to allow the stations STA1-STA3 (and the AP 110) to ignore the BSS color information in received communication frames. This may prevent the stations STA1-STA3 and AP 110 from filtering or discarding incoming communication frames based on their BSS color. Thus, while the BSS color check procedure is disabled, the stations STA1-STA3 and AP 110 may implement the BSS color change at different times (such as at TBTTs associated with their respective PHY formats) without any interruption in communications between the devices.

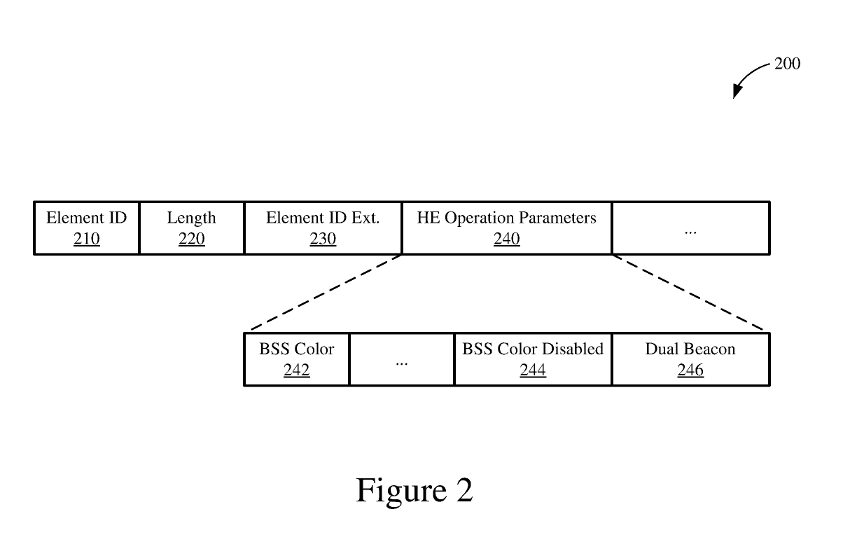

FIG. 2 shows an example HE Operation element 200 that may be provided in beacon (or other management) frames transmitted by the AP 110. The HE Operation element 200 may include an “Element ID” field 210, a “Length” field 220, an “Element ID Extension” field 230, an “HE Operation Parameters” field 240, and one or more additional fields for optional sub-elements (not shown for simplicity). The Element ID field 210 may store 1 byte of information identifying the element 200 as an HE Operation element. The Length field 220 may store 1 byte of information indicating the length of the HE Operation element 200. The Element ID Extension field 230 may store an additional byte of information as an extension to the Element ID field 210. The HE Operation Parameters field 240 may store up to 4 bytes of information indicating one or more HE operations or parameters supported by the AP or BSS associated with the HE Operation element 200.

The HE Operation Parameters field 240 may include a “BSS Color” subfield 242, a “BSS Color Disabled” subfield 244, and a “Dual Beacon” subfield 246. The BSS Color subfield 242 may store up to 6 bits of information indicating a BSS color associated with the AP or BSS. For example, the BSS color may be used to differentiate communications intended for a particular BSS from communications intended for an overlapping BSS or any other BSSs in the vicinity. The BSS Color Disabled subfield 244 may store 1 bit of data indicating whether a BSS color check procedure should be disabled (or enabled) for the corresponding BSS. For example, a value of 0 in the BSS Color Disabled subfield 244 may indicate that the BSS color check procedure should be enabled (causing HE devices to filter incoming communication frames based on the BSS color indicated in the BSS Color subfield 242). A value of 1 in the BSS Color Disabled subfield 244 may indicate that the BSS color check procedure should be disabled (causing HE devices to ignore the BSS color of incoming communication frames). The Dual Beacon subfield 246 may store at least 1 bit of data indicating whether the originating AP transmits beacon frames in multiple PHY formats. For example, a value of 0 in the Dual Beacon subfield 246 may indicate that the AP transmits beacons in the primary frame format. A value of 1 in the Dual Beacon subfield 246 may indicate that the AP transmits beacons in the primary frame format and the secondary frame format.

In some implementations, an HE AP may support multiple PHY formats through a single BSS. For example, the AP may operate as a single BSS configured for dual beacon functionality. Thus, the AP may transmit communication frames formatted in accordance with the primary frame format and the secondary frame format on behalf of the same BSS. In such implementations, the AP may advertise its support for dual beacon functionality, for example, by storing a value of 1 in the Dual Beacon subfield 246 of beacon (or other management) frames transmitted by the AP. In some other implementations, an HE AP may support multiple PHY formats through multiple BSSs. For example, the AP may operate as a plurality of “virtual” BSSs that are individually configured for a particular PHY format. Thus, the AP may transmit communication frames formatted in accordance with the primary frame format on behalf of a first (virtual) BSS and may transmit communication frames formatted in accordance with the secondary frame format on behalf of a second (virtual) BSS. In such implementations, the AP may advertise that it does not support dual beacon functionality, for example, by storing a value of 0 in the Dual Beacon subfield 246 of beacon (or other management) frames transmitted by the AP. Further, when operating as a plurality of BSSs, an AP may advertise the presence of co-located BSSs (that support different PHY formats).

It is noted that different frame formats may perform better than others under different channel conditions or distances between wireless devices. For example, the extended range (ER) format (included in the IEEE 802.11ax specification) is a particular PHY format that may allow wireless device to communicate more effectively over greater distances than legacy or non-ER frame formats. The ER format may offer more robust performance over longer distances, for example, by boosting the power and repeating the information carried in the communication frames. However, this feature also may reduce the rate at which data can be transmitted, thus making the ER frame format less desirable (compare to non-ER frame formats) for close-range communications. Thus, STAs that are closer in proximity to an HE AP may prefer to communicate using the ER frame format, whereas STAs that are further from the AP may prefer to communicate using a non-ER frame format.

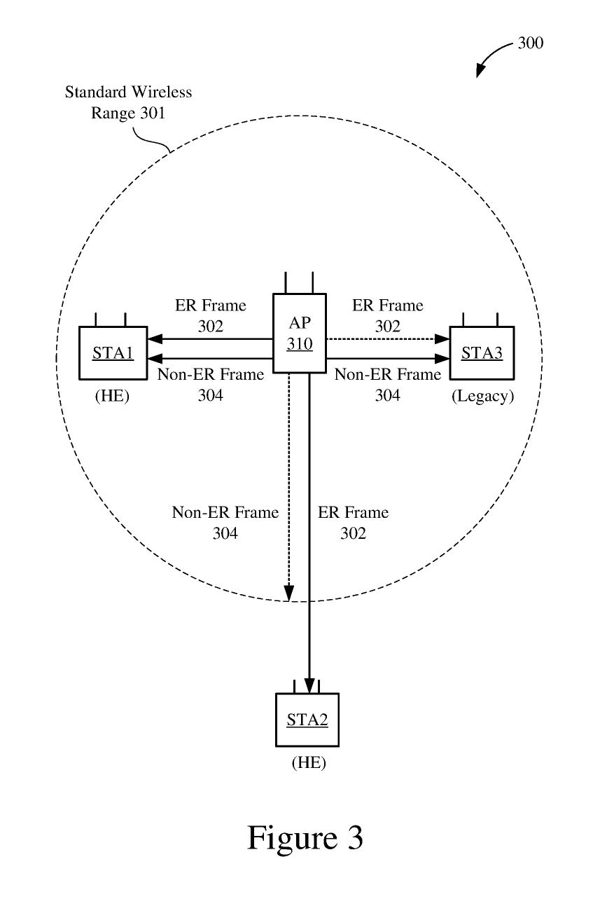

FIG. 3 shows an example wireless system 300 capable of supporting multiple PHY formats. The wireless system 300 is shown to include an access point AP 310 and a number of wireless stations STA1-STA3. With reference, for example, to the wireless system 100 of FIG. 1, the AP 310 may be an implementation of the AP 110. Thus, in the example of FIG. 3, the AP 310 is an HE AP, wireless stations STA1 and STA2 are HE STAs, and STA3 is a legacy STA. Although three wireless stations STA1-STA3 are shown in the example of FIG. 3 for simplicity, it is to be understood that the wireless system 300 may include any number of STAs.

As shown in FIG. 3, wireless stations STA1 and STA3 are within a standard wireless range 301 of the AP 310. The second wireless station STA2 is beyond the standard wireless range 301. The standard wireless range 301 corresponds to a maximum communication range of the AP 310 using conventional wireless signaling techniques (such as provided under legacy IEEE 802.11 protocols). For example, any legacy communication frames (transmitted by the AP 310) that propagate beyond the standard wireless range 301 may have such a low signal-to-noise ratio (SNR) that they cannot be properly received or decoded by a receiving device. Accordingly, the standard wireless range 301 may represent a threshold distance at which a STA may effectively receive legacy communication frames transmitted or broadcast by the AP 310.

In some implementations, the AP 310 may be configured to transmit communication frames in the ER format to one or more of the wireless stations STA1-STA3. In the example of FIG. 3, stations STA1 and STA2 are HE STAs (capable of implementing ER protocols such as described, for example, by the IEEE 802.11ax specification), and STA3 is a legacy STA (not capable of implementing ER protocols). Since stations STA1 and STA3 are within the standard wireless range 301, the AP 310 may communicate with the stations STA1 and STA3 using legacy or non-ER communication protocols. However, because STA2 is beyond the standard wireless range 301, any non-ER frames transmitted or broadcast by the AP 310 may not be able to reach STA2. Thus, the AP 310 may be able to communicate with STA2 using solely ER communication protocols.

To provide support for both legacy and HE STAs, the AP 310 may transmit the same information (intended for one or more of the stations STA1-STA3) in the ER format and in a non-ER format. For example, the IEEE 802.11ax specification describes a dual beacon operation in which an HE AP periodically broadcasts beacon frames in the legacy format (such as to maintain connectivity with any legacy or HE STAs within a standard wireless range) and the ER format (such as to maintain connectivity with any HE STAs beyond the standard wireless range). In some implementations, the AP 310 may transmit broadcast or multicast information to the stations STA1-STA3 via communication frames formatted in accordance with the ER format (ER frames 302) and a non-ER format (non-ER frames 304). Because some of the STAs (such as STA2) may be beyond the standard wireless range 301 of the AP 310, and some of the STAs (such as STA1) may only be capable of legacy communications, the AP 310 may transmit the same broadcast or multicast information to the group of stations STA1-STA3 in the non-ER format as well as the ER format.

Since STA3 is a legacy STA, STA3 may not be able to receive or process the ER frames 302. Thus, STA3 may receive the broadcast or multicast information via the non-ER frames 304. Since STA2 is beyond the standard wireless range 301 of the AP 310, the non-ER frames 304 may not reach STA2. Thus, STA2 may receive the broadcast or multicast information via the ER frames 302. However, because STA1 is an HE STA and is within the standard wireless range 301 of the AP 310, STA1 may receive both the ER frames 302 and the non-ER frames 304 transmitted by the AP 310. It is noted that, ER frames are typically transmitted at lower signaling rates than non-ER frames. However, it is also noted that interference in the wireless channel may have a greater effect on non-ER frames (than ER frames), thus causing non-ER frames to be retransmitted more frequently. Thus, the AP 310 may communicate more effectively with STA1 via the ER frames 302 when STA1 is within the standard wireless range 301. However, if there is substantial interference in the wireless channel, the AP 310 may communicate more effectively with STA1 using the non-ER frames 304.

In some implementations, the AP 310 may implement a change to one or more of its BSS parameters (such as a wireless channel or BSS color) during a TBTT associated with the non-ER format (herein referred to as a “legacy TBTT”). For example, the AP 310 may broadcast a change-in-BSS announcement message indicating the new BSS parameters and the legacy TBTT at which the new BSS parameters are to be implemented (such as an absolute time or a subsequent number of legacy TBTTs). To signal the change in BSS to each of its associated stations STA1-STA3, the AP 310 may broadcast the announcement message via the non-ER frames 304 and ER frames 302. However, in some aspects, the AP 310 may broadcast ER frames 302 at different times than the non-ER frames 304. In other words, the legacy TBTTs may be offset relative to TBTTs associated with the ER format (herein referred to as “ER TBTTs”). Thus, HE STAs that are beyond the standard wireless range 301 (such as STA2) may be unaware of the timing of the legacy TBTTs. In some implementations, the AP 310 may provide additional timing information in the ER frames 302 pointing to the legacy TBTTs. For example, the additional timing information may indicate an absolute timing of the legacy TBTTs or a relative timing offset between legacy TBTTs and ER TBTTs.

In some other implementations, the AP 310 may implement the change to one or more of its BSS parameters during a period of time in which selected BSS features are disabled. For example, when implementing the change in BSS, the AP 310 may first disable certain BSS features related to the BSS parameters to be changed. The AP 310 may then broadcast a change-in-BSS announcement message to each of the stations STA1-STA3, via the non-ER frames 304 and ER frames 302, indicating the new BSS parameters and one or more times at which the new BSS parameters are to be implemented. In some aspects, the change in BSS may be implemented at different times for different PHY formats. For example, the announcement message provided in the non-ER frames 304 may indicate that the change in BSS is to occur at a particular legacy TBTT, whereas the announcement message provided in the ER frames 302 may indicate that the change in BSS is to occur at a particular ER TBTT. As a result, STAs that operate in accordance with the ER format (such as STA2) may implement the new BSS parameters at the ER TBTT specified in the ER frames 302. On the other hand, STAs that operate in accordance with a non-ER format (such as STA1 or STA3) may implement the new BSS parameters at the legacy TBTT specified in the non-ER frames 304. Since selected functionality related to the new BSS parameters is disabled during this time, the stations STA1-STA3 may continue communicating with the AP 310 without interruption (even though the STAs may implement the new BSS parameters at different times). After each of the stations STA1-STA3 has successfully performed the change in BSS, the AP 310 may re-enable the selected BSS features.

By providing information in ER frames 302 about legacy TBTTs, the AP 310 may enable STAs operating in accordance with the ER format to implement new BSS parameters at substantially the same time as STAs operating in accordance with non-ER formats. This may allow the AP 310 to dynamically change one or more of its BSS configurations (such as switching to a new wireless channel or a new BSS color) in response to changes or interference in the wireless environment. Furthermore, by temporarily disabling selected BSS features, the AP 310 may enable STAs operating in accordance with different PHY formats (such as STAs operating in accordance with the ER and STAs operating in accordance with non-ER formats) to implement new BSS parameters according to their respective TBTTs (such as ER TBTTs or legacy TBTTs). This may reduce the overheard required to signal and process a change in BSS.

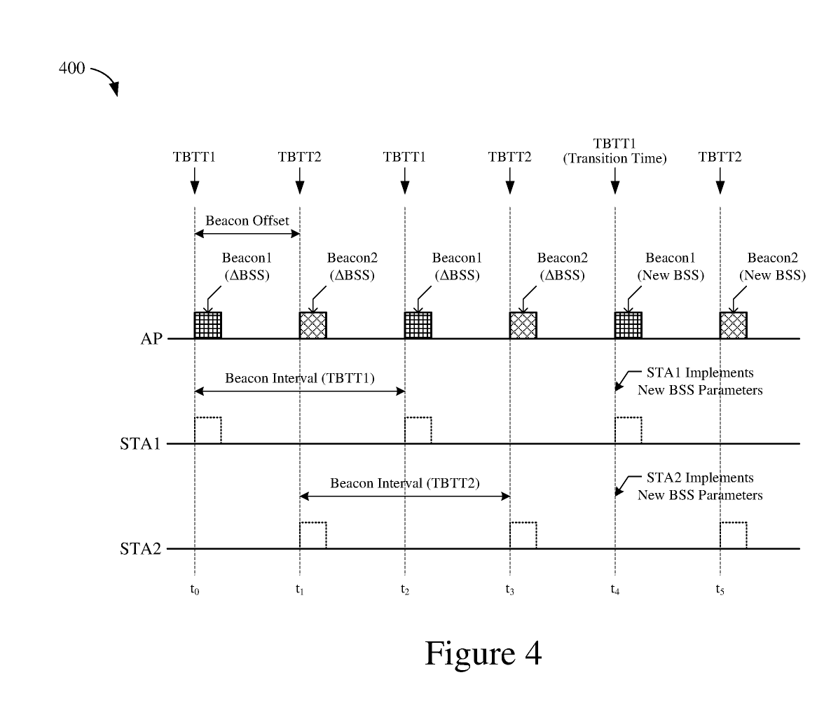

FIG. 4 shows a timing diagram depicting an example operation 400 for implementing changes in a basic service set (BSS) that supports multiple PHY formats. The AP and wireless stations STA1 and STA2 may be example implementations of the AP 110 and wireless stations STA1 and STA2, respectively, of FIG. 1. In the example of FIG. 4, the AP may communicate with STA1 using a primary PHY format (such as a non-ER format), and may communicate with STA2 using a secondary PHY format (such as the ER format). Accordingly, the AP may broadcast beacon information to STA1 at primary TBTTs (TBTT1) and may broadcast beacon information to STA2 at secondary TBTTs (TBTT2). As shown in FIG. 4, the primary TBTTs are offset relative to the secondary TBTTs. For simplicity, two wireless stations STA1 and STA2 are shown in the example of FIG. 4. However, in other implementations, the AP may communicate with fewer or more STAs than those depicted in FIG. 4.

In the example of FIG. 4, the AP may decide to implement a change to one or more settings or parameters of its BSS. In some aspects, the change in BSS may correspond to a change in wireless channel. For example, the AP may determine that its current wireless channel has too much interference or is overcrowded. In some other aspects, the change in BSS may correspond to a change in BSS color. For example, the AP may determine that its current BSS color is being used by one or more overlapping BSSs (such as one or more other BSSs in the vicinity of the AP). It may be desirable to implement the change to the BSS parameters at a time when all (or at least most) of the associated STAs are listening to the AP. Thus, in some implementations, the AP may perform the change in BSS during a TBTT (such as at the start of a beacon interval or Delivery Traffic Indication Map (DTIM) period), when its associated STAs expect to receive a beacon frame from the AP. To ensure that each of its associated STAs (including any STAs that may currently be in a power save state) has an opportunity to receive a change-in-BSS announcement message, the AP may schedule the change to occur after a number of TBTT or beacon intervals have passed. In the example of FIG. 4, the change in BSS may coincide with a primary TBTT at time t₄ (referred to herein as the “target transition time”).

At time t₀, the AP broadcasts a beacon (or other management) frame in accordance with the primary PHY format. The beacon frame broadcast at time t₀ may include a change-in-BSS (ΔBSS) announcement message signaling a change to be implemented to one or more BSS parameters of the AP. For example, the ΔBSS announcement message may include information specifying the type of change to occur (such as a change in wireless channel or BSS color) and the time at which the change in BSS is to be implemented (such as at time t₄ or in two subsequent primary TBTTs). STA1 receives the information from the beacon broadcast at time t₀, and may prepare to implement the change in BSS at the target transition time (time t₄).

At time t₁, the AP broadcasts a beacon (or other management) frame in accordance with the secondary PHY format. The beacon frame broadcast at time t₁ also may include a ΔBSS announcement message signaling the change to be implemented to the one or more BSS parameters of the AP. For example, ΔBSS announcement message may include information specifying the type of change to occur (such as a change in wireless channel or BSS color) and the time at which the change in BSS is to be implemented (such as at time t₄ or in two subsequent primary TBTTs). In some implementations, the ΔBSS announcement message may further include information indicating a timing of the primary TBTTs (such as a relative offset between the primary TBTTs and the secondary TBTTs). STA1 receives the information from the beacon broadcast at time t₁, and may prepare to implement the change in BSS at the target transition time (time t₄).

At time t₂, the AP broadcasts another beacon (or other management) frame in accordance with the primary PHY format. The beacon frame broadcast at time t₂ may once again include the ΔBSS announcement message signaling the change in BSS to STAs operating in accordance with the primary PHY format (including any STAs that may have missed the beacon broadcast at time t₀). For example, the ΔBSS announcement message may include information specifying the type of change to occur and the time at which the change in BSS is to be implemented (such as at the next primary TBTT). At time t₃, the AP broadcasts another beacon (or other management) frame in accordance with the secondary PHY format. The beacon frame broadcast at time t₃ may once again include the ΔBSS announcement message signaling the change in BSS to STAs operating in accordance with the secondary PHY format (including any STAs that may have missed the beacon broadcast at time t₁). For example, the ΔBSS announcement message may include information specifying the type of change to occur, the time at which the change in BSS is to be implemented (such as at the next primary TBTT), and a timing of the primary TBTTs.

The AP and each of its associated wireless stations STA1 and STA2 may implement the new BSS parameters at, or prior to, time t₄. For example, the wireless stations STA1 and STA2 may switch to a new wireless channel or a new BSS color (as provided by the ΔBSS announcement message). Then, at time t₄, the AP broadcasts a new beacon (or other management) frame in accordance with the primary PHY format. This new beacon frame may be broadcast using the new BSS parameters. For example, the new beacon frame may be broadcast on the new wireless channel or with the new BSS color now being used by the AP and its associated wireless stations STA1 and STA2. At time t₅, the AP broadcasts a new beacon frame in accordance with the secondary PHY format. This new beacon frame also may be broadcast using the new BSS parameters (such as the new wireless channel or the new BSS color now being used by the AP and stations STA1 and STA2).

Accordingly, the AP and the wireless stations STA1 and STA2 may proceed to use the new BSS parameters once the target transition time (time t₄) has been reached. It is noted that, in the example of FIG. 4, the wireless stations STA1 and STA2 may implement the new BSS parameters at substantially the same time (time t₄) even though the target transition time does not coincide with a TBTT associated with the second PHY format. Thus, aspects of the present disclosure may enable a STA operating in accordance with a particular PHY format (such as the second PHY format) to implement a change to one or more of its BSS parameters based on a timing of beacon transmissions configured for a different PHY format (such as the first PHY format). In some other implementations, each of the wireless stations STA1 and STA2 may implement the change in BSS at different times, for example, based on a timing of beacon transmissions configured for their respective PHY formats.

The IEEE 802.11ax specification defines a BSS color indicator that may be used to differentiate BSSs in dense deployment scenarios. The BSS color indicator may be included in a physical layer (PHY) header (such as a high efficiency signaling A (HE SIG A) field) of communication frames exchanged between HE devices. Since the BSS color indicator is provided in the PHY header, a STA that is within wireless range of two “overlapping” BSSs may quickly differentiate wireless communications intended for its own BSS, from wireless communications intended for an overlapping BSS, by inspecting the BSS color of any received communication frame. More specifically, this allows the STA to filter incoming communications from unwanted APs without looking at the source address of each received communication frame (which is typically processed in the media access control layer (MAC)). However, because there are a finite number of “colors” to choose from (the IEEE 802.11ax specification defines the BSS color indicator as a 6-bit value), there may be instances where some overlapping BSSs have the same color (referred to herein as a “color collision”). This may prompt an AP to change its BSS color.

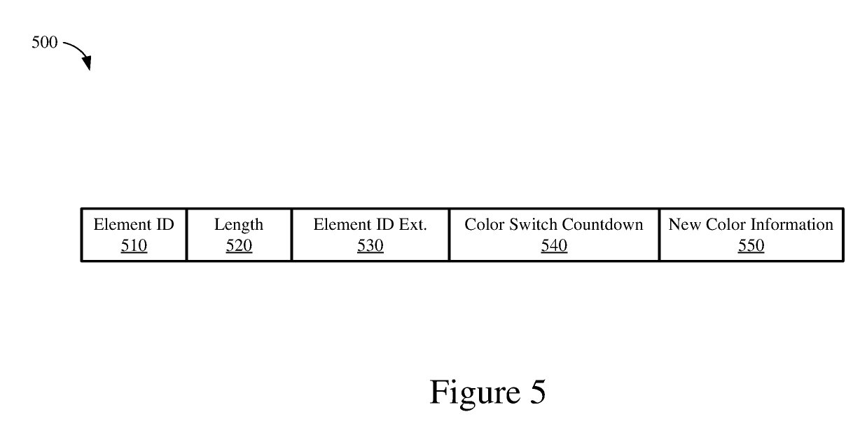

FIG. 5 shows an example BSS color change announcement element 500. In some implementations, the BSS color change announcement element 500 may correspond to a change-in-BSS (ΔBSS) announcement message that may be provided within beacon frames, probe response frames, association or re-association frames, or various other communication frames that may be transmitted or broadcast by an AP to one or more STAs. The example BSS color change announcement element 500 includes an element identification (ID) field 510, a length field 520, an element ID extension field 530, a color switch countdown field 540, and a new color information field 550. In some aspects, each of the fields 510-550 may be an octet in length.

The color switch countdown field 540 may include a countdown timer indicating the number of TBTT periods or beacon intervals remaining until the target transition time. The new color information field 550 may indicate the new BSS color (or other BSS parameter) to be used at the target transition time. In some implementations, the new color information field 550 may be used to notify a STA of the new BSS color, prior to the color-switching time, so that the STA may switch to the new BSS color even if it is in a power save state at the time the new BSS color is scheduled to take effect. In some aspects, the new color information field 550 may include six bits that are used to indicate the new BSS color, whereas the remaining two bits may be used for other information (such as changes to other BSS parameters) or may be reserved for future use.

In some implementations, the BSS color change announcement element 500 may be used to change the BSS color of an AP at different times for different STAs (such as STAs operating in accordance with different PHY formats). When changing the BSS color for different STAs at different times, there may be a period of time in which some STAs have implemented the new BSS color whereas other STAs are still implementing the old BSS color. To ensure continuity of communications during this “transition period,” it may be desirable to temporarily disable certain BSS color-related features to ensure that devices honoring the old BSS color (including the AP or STAs) do not filter or ignore incoming communication frames tagged with (or indicating) the new BSS color (or to ensure that devices honoring the new BSS color do not filter or ignore incoming communication frames tagged with the old BSS color). With reference for example to FIG. 2, an AP may disable a BSS color check procedure by storing a value of 1 in the BSS Color Disabled subfield 244 in the HE Operation element 200 of beacon (or other management) frames transmitted to its associated STAs. The AP may then re-enable the BSS color-related features after each of its associated STAs has successfully switched to the new BSS color.

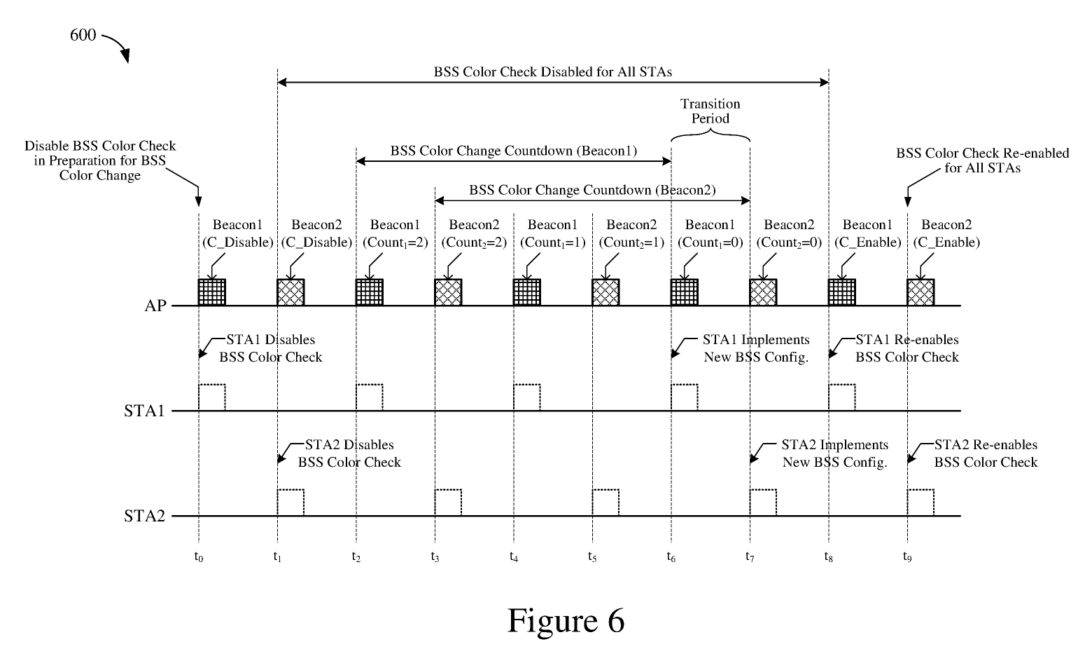

FIG. 6 shows a timing diagram depicting an example BSS color change operation 600 that supports multiple PHY formats. The AP and wireless stations STA1 and STA2 may be example implementations of the AP 110 and wireless stations STA1 and STA2, respectively, of FIG. 1. In the example of FIG. 6, the AP may communicate with STA1 using a primary PHY format (such as a non-ER format) and may communicate with STA2 using a secondary PHY format (such as the ER format). Accordingly, the AP may broadcast beacon information to STA1 at primary TBTTs and may broadcast beacon information to STA2 at secondary TBTTs. For simplicity, two wireless stations STA1 and STA2 are shown in the example of FIG. 6. However, in some other implementations, the AP may communicate with fewer or more STAs than those depicted in FIG. 6.

In the example of FIG. 6, the AP may decide to implement a change to its BSS color. To implement the change in BSS color, the AP may first disable color-related features in each HE device associated with the BSS (including the AP and the stations STA1 and STA2). For example, the AP may disable a BSS color check procedure using the HE Operation element of beacon (or other management) frames transmitted to its associated STAs. With the BSS color check operation disabled, HE devices (including the AP and its associated STAs) may ignore the BSS color of incoming communication frames. As a result, the HE devices will not filter or discard any incoming communication frames on the basis of their BSS color. Thus, while the BSS color check operation is disabled, the HE devices may proceed to analyze the source address (in the MAC header) of each incoming communication frame to determine whether the communication frame originated from a desired (or unwanted) source.

At time t₀, the AP broadcasts a beacon (or other management) frame in accordance with the primary PHY format. The beacon frame broadcast at time t₀ may be used to disable a BSS color check operation in STAs operating in accordance with the primary PHY format. With reference for example to FIG. 2, the AP may disable the BSS color check procedure by storing a value of 1 in the BSS Color Disabled subfield 244 in the HE Operation element 200 of the beacon frame broadcast at time t₀. Upon receiving the beacon broadcast at time t₀, STA1 may proceed to disable its BSS color check operation for at least the duration of the current beacon interval (from times t₀ to t₂). With the BSS color check operation disabled, STA1 may continue receiving communication frames from the AP (and filtering incoming frames from other BSSs based on the source address of the incoming frames).

At time t₁, the AP broadcasts a beacon (or other management) frame in accordance with the secondary PHY format. The beacon frame broadcast at time t₀ may be used to disable a BSS color check operation in STAs operating in accordance with the secondary PHY format. As described above, the AP may disable the BSS color check procedure by storing a value of 1 in the BSS Color Disabled subfield 244 in the HE Operation element 200 of the beacon frame broadcast at time t₁. Upon receiving the beacon broadcast at time t₁, STA2 may proceed to disable its BSS color check operation for at least the duration of the current beacon interval (from times t₁ to t₃). With the BSS color check operation disabled, STA2 may continue receiving communication frames from the AP (and filtering incoming frames from other BSSs based on the source address of the incoming frames).

At time t₂, the AP initiates a BSS color change countdown for STAs operating in accordance with the primary PHY format. The AP may signal the BSS color change countdown by transmitting or broadcasting a beacon frame (or other communication frame such as, for example, a probe response frame, an association response frame, or a reassociation response frame), in the primary PHY format, pointing to a subsequent beacon frame or TBTT of the same (primary) PHY format. In the example of FIG. 6, the BSS color change countdown is signaled via a beacon frame broadcast at a primary TBTT. The beacon frame broadcast at time t₂ may include a BSS color change announcement element (such as the BSS color change announcement element 500 of FIG. 5) identifying the new BSS color that is scheduled to take effect at a color-switching time of the primary PHY format, as well as a countdown to the color-switching time. In some implementations, the color-switching time of the primary PHY format may coincide with a subsequent primary TBTT (such as at time t₆). Thus, the countdown may indicate a number of primary TBTTs or beacon intervals remaining before the color change operation is to be implemented by STAs operating in accordance with the primary PHY format (Count₁=2). In some implementations, the beacon broadcast at time t₂ may further indicate that the BSS color check operation is still disabled. Upon receiving the beacon broadcast at time t₂, STA1 may prepare to implement the new BSS color at the color-switching time (time t₆) while continuing to ignore the BSS color of incoming communication frames for the duration of the current beacon interval (from times t₂ to t₄).

At time t₃, the AP initiates a BSS color change countdown for STAs operating in accordance with the secondary PHY format. The AP may signal the BSS color change countdown by transmitting or broadcasting a beacon frame (or other communication frame such as, for example, a probe response frame, an association response frame, or a reassociation response frame), in the secondary PHY format, pointing to a subsequent beacon frame or TBTT of the same (secondary) PHY format. In the example of FIG. 6, the BSS color change countdown is signaled via a beacon frame broadcast at a secondary TBTT. The beacon frame broadcast at time t₃ may include a BSS color change announcement element (such as the BSS color change announcement element 500 of FIG. 5) identifying the new BSS color that is scheduled to take effect at a color-switching time of the secondary PHY format, as well as a countdown towards the color-switching time. In some implementations, the color-switching time of the secondary PHY format may coincide with a subsequent secondary TBTT (such as at time t₇). Thus, the countdown timer may indicate a number of secondary TBTTs or beacon intervals remaining before the color change operation is to be implemented by STAs operating in accordance with the secondary PHY format (Count₂=2). In some implementations, the beacon broadcast at time t₃ may further indicate that the BSS color check operation is still disabled. Upon receiving the beacon broadcast at time t₃, STA2 may prepare to implement the new BSS color at the color-switching time of the secondary PHY format (time t₇) while continuing to ignore the BSS color of incoming communication frames for the duration of the current beacon interval (from times t₃ to t₅).

At time t₄, the AP broadcasts another beacon (or other management) frame in accordance with the primary PHY format. The beacon frame broadcast at time t₄ may once again signal the change in BSS color to STAs operating in accordance with the primary PHY format (including any STAs that may have missed the beacon broadcast at time t₂). For example, the beacon frame may include a BSS color change announcement element identifying the new BSS color that is scheduled to take effect at the color-switching time of the primary PHY format, as well as an updated countdown towards the color-switching time (Count₁=1). In some implementations, the beacon broadcast at time t₄ may further indicate that the BSS color check operation should continue to be disabled for at least the duration of the current beacon interval (from times t₄ to t₆).

At time t₅, the AP broadcasts another beacon (or other management) frame in accordance with the secondary PHY format. This beacon frame broadcast at time t₅ may once again signal the change in BSS color to STAs operating in accordance with the secondary PHY format (including any STAs that may have missed the beacon broadcast at time t₃). For example, the beacon frame may include a BSS color change announcement element identifying the new BSS color that is scheduled to take effect at the color-switching time of the secondary PHY format, as well as an updated countdown towards the color-switching time (Count₂=1). In some implementations, the beacon broadcast at time t₅ may further indicate that the BSS color check operation should continue to be disabled for at least the duration of the current beacon interval (from times t₅ to t₇).

At time t₆, the AP broadcasts another beacon (or other management) frame in accordance with the primary PHY format. In the example of FIG. 6, time t₆ coincides with the color-switching time of the primary PHY format. Thus, the beacon frame broadcast at time t₆ may include a BSS color change announcement element identifying the new BSS color, as well as an updated countdown indicating that the new BSS color is to take effect at this time (Count₁=0). In some implementations, the beacon broadcast at time t₆ may further indicate that the BSS color check operation should continue to be disabled. Upon receiving the beacon broadcast at time t₆, STA1 may proceed to implement the new BSS color while continuing ignore the BSS color of incoming communication frames for the duration of the current beacon interval (from times t₆ to t₈).

At time t₇, the AP broadcasts another beacon (or other management) frame in accordance with the secondary PHY format. In the example of FIG. 6, time t₇ coincides with the color-switching time of the secondary PHY format. Thus, the beacon frame broadcast at time t₇ may include a BSS color change announcement element identifying the new BSS color, as well as an updated countdown indicating that the new BSS color is to take effect at this time (Count₂=0). In some implementations, the beacon broadcast at time t₇ may further indicate that the BSS color check operation should continue to be disabled. Upon receiving the beacon broadcast at time t₇, STA2 may proceed to implement the new BSS color while continuing to ignore the BSS color of incoming communication frames for the duration of the current beacon interval (from times t₇ to t₉).

In the example of FIG. 6, the STA1 switches to the new BSS color before STA2. Thus, during this transition period (from times t₆ to t₇), each of the wireless stations STA1 and STA2 may be configured for a different BSS color. For example, after time t₆ but before time t₇, STA1 may have switched to the new BSS color while STA2 may still recognize the old BSS color. However, because the BSS color check operation is disabled, each of the stations STA1 and STA2 may continue receiving communication frames from the AP, without interruption. The “actual” transition time for the change in BSS color (as implemented by the AP) may therefore occur at any time between the color-switching times of the various STAs. In other words, the AP may begin transmitting communication frames with the new BSS color at any time between times t₆ and t₇ (inclusive).

After the BSS color change has been implemented with respect to each of multiple PHY formats supported by the AP, the AP may then re-enable the BSS color check operation in each of the HE devices associated with the BSS (including the AP and the wireless stations STA1 and STA2). With reference for example to FIG. 2, the AP may disable a BSS color check procedure by storing a value of 0 in the BSS Color Disabled subfield 244 in the HE Operation element 200 of beacon (or other management) frames transmitted to its associated STAs.

At time t₈, the AP may broadcast a beacon (or other management) frame to re-enable the BSS color check operation in STAs operating in accordance with the primary PHY format. Upon receiving the beacon broadcast at time t₈, STA1 may proceed to re-enable its BSS color check operation. At time t₉, the AP may broadcast a beacon (or other management) frame to re-enable the BSS color check operation in STAs operating in accordance with the secondary PHY format. Upon receiving the beacon broadcast at time t₉, STA2 may proceed to re-enable its BSS color check operation. With the BSS color-related features re-enabled, the wireless stations STA1 and STA2 (as well as the AP) may resume filtering incoming communication frames based on their BSS color.

In some implementations, the AP may disable the BSS color check operation a number (M) of beacon intervals (or TBTTs) prior to initiating the color change countdown. For example, as shown in FIG. 6, the AP disables the BSS color check operation with respect to each of the primary and secondary PHY formats one beacon interval prior to initiating the BSS color change countdown for the respective PHY format (M=1). Further, in some implementations, the AP may re-enable the BSS color check operation a number (L) of beacon intervals after the color change countdown has terminated. For example, as shown in FIG. 6, the AP re-enables the BSS color check operation with respect to each of the primary and secondary PHY formats one beacon interval after completing the BSS color change for each the respective PHY format (L=1). Accordingly, the values of M and L provide a buffer for the BSS color change operation (from times t₂ to t₇) to ensure that the BSS color check feature is disabled for each of the associated stations STA1 and STA2 when two or more of the STAs could potentially be configured a different BSS color. This further ensures continuity of communications between the AP and the stations STA1 and STA2 while the BSS color change operation takes place.

It is noted that, in the example of FIG. 6, the AP may implement a change in BSS by leveraging existing protocols defined by the IEEE 802.11ax specification. This may reduce the implementation complexity of the BSS color change operation described herein, since little or no modification is made to the beacon frames described in the IEEE 802.11ax specification. This also may reduce the overhead of communications between the AP and the wireless stations STA1 and STA2, since the AP does not need to provide additional information for synchronizing the BSS color change among each of the STAs to a single point in time (such as in the example of FIG. 4).

In some implementations, rather than transmit duplicate communication frames (in different PHY formats) on behalf of the same BSS, an HE AP may be configured as a plurality of “virtual” BSSs each configured for a different PHY format. For example, an AP hosting multiple BSSIDs may be configured to provide multiple virtual local area networks (VLANs), where each VLAN corresponds to a respective BSS. Each virtual BSS may be identified by a different BSS identifier (BSSID). Accordingly, different STAs may connect to different VLANs by associating with the corresponding BSS. In some aspects, each virtual BSS may be configured to format communication frames in accordance with a single PHY format (such as the ER format or the non-ER format). However, since different BSSs may be configured for different PHY formats, the same (physical) AP may still be able to support a plurality of different PHY formats.

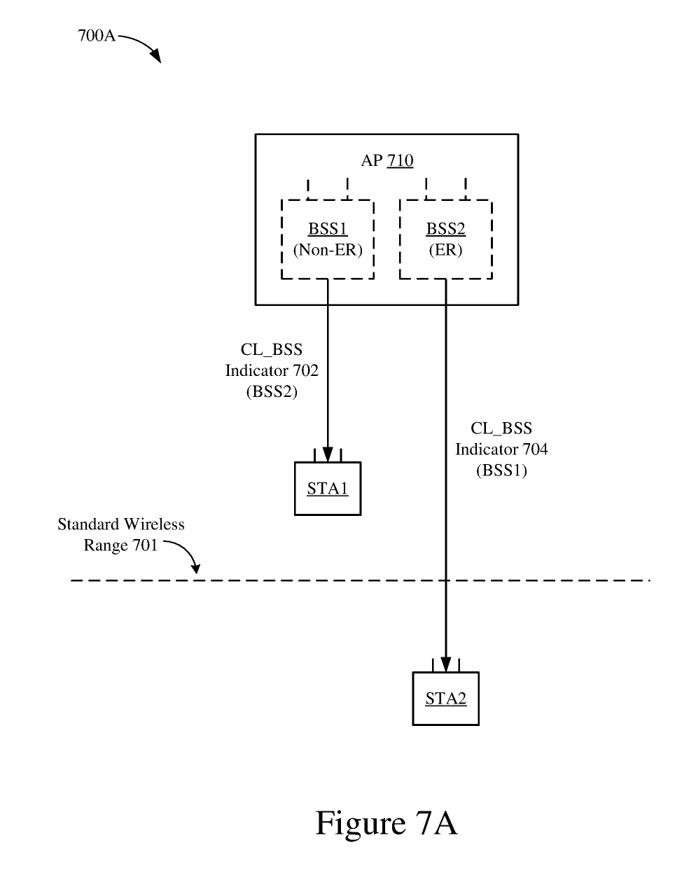

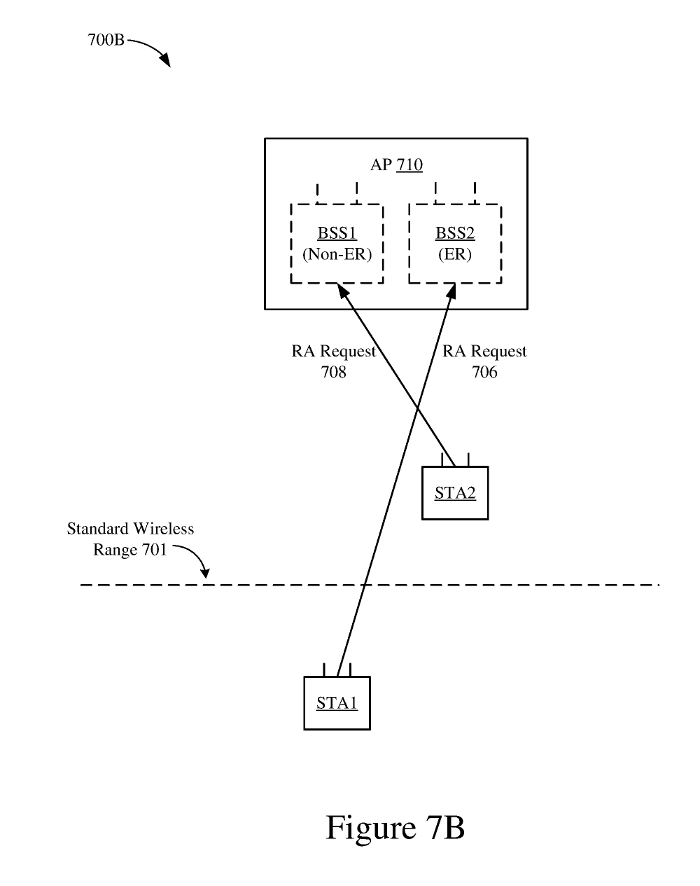

FIG. 7A shows another example wireless system 700A capable of supporting multiple PHY formats. The wireless system 700A is shown to include an access point AP 710 and wireless stations STA1 and STA2. In the example of FIG. 7A, the AP 710 is an HE AP serving as two Basic Service Sets BSS1 and BSS2, and the wireless stations STA1 and STA2 are HE STAs. Although two Basic Service Sets BSS1 and BSS2 are shown in the example of FIG. 7A for simplicity, it is to be understood that the AP 710 may serve as any number of virtual BSSs.

In some implementations, each of the Basic Service Sets BSS1 and BSS2 is configured for a different PHY format. For example, BSS1 may be configured to format communication frames in accordance with the non-ER format, and BSS2 may be configured to format communication frames in accordance with the ER format. Thus, BSS1 may support legacy STAs (not shown for simplicity) and HE STAs that are within a standard wireless range 701 of the AP 710 (or otherwise prefer the non-ER format). On the other hand, BSS2 may support HE STAs that are beyond the standard wireless range 701 (or otherwise prefer the ER format). In some aspects, neither of the Basic Service Sets BSS1 or BSS2 is configured to support multiple PHY formats.

In the example of FIG. 7A, STA1 is within the standard wireless range 701 of the AP 710 and STA2 is beyond the standard wireless range 701. Since STA1 is within the standard wireless range 701, STA1 may take advantage of the higher signaling rates provided by the non-ER format. Accordingly, STA1 may be initially associated with BSS1. For example, when scanning for a BSS to associate with, STA1 may detect ER beacons (or probe responses) from BSS2 and non-ER beacons (or probe responses) from BSS1. Upon receiving a beacon or probe response frame formatted in accordance with the non-ER format, STA1 may proceed to associate with BSS1. Since STA2 is beyond the standard wireless range 701, STA2 may communicate with the AP 710 using the ER format. Accordingly, STA2 may be initially associated with BSS2. For example, since it is beyond the range of BSS1, STA2 may detect ER beacons (or probe responses) from BSS2 when scanning for a BSS to associate with. Upon receiving a beacon or probe response frame formatted in accordance with the ER format, STA2 may proceed to associate with BSS2.

In some implementations, the PHY format implemented by a particular STA may dynamically change based on movements of the STA or changing channel conditions. Thus, it may be desirable to allow any HE STA associated with the AP 710 to dynamically switch the virtual BSS with which it is associated (such as between BSS1 and BSS2). In some implementations, each of the Basic Service Sets BSS1 and BSS2 may be configured to transmit a respective co-located BSS (CL_BSS) indicator 702 and 704 to any STAs in the vicinity of the AP 710. For example, the CL_BSS indicators 702 and 704 may be included in beacon frames, probe response frames, or other management frames transmitted by a BSS. In some implementations, each of the CL_BSS indicators 702 and 704 may indicate the identity and supported PHY format of a co-located BSS. As used herein, the term “co-located BSS” may refer to any BSSs that occupy substantially the same physical location or share one or more hardware components (such as the antenna connectors of an AP). Thus, virtual BSSs belonging to the same physical AP (such as BSS1 and BSS2) may be referred to as co-located BSSs.

In some implementations, the CL_BSS indicator may be provided in a neighbor report. For example, the neighbor report (as defined by the IEEE 802.11 standards) may indicate the presence, locations, and capabilities of other BSSs in the vicinity of an associated BSS (or the BSS that generated the report). In some aspects, the neighbor report may include one or more bits of information indicating the PHY format supported by each BSS identified in the report (such as whether the BSS is configured for the ER or non-ER format) and a bit of information indicating whether each identified BSS is co-located with the BSS that generated the report. The neighbor report also may include additional information about the capabilities or operating parameters for each BSS identified in the report. In the example of FIG. 7A, the CL_BSS indicator 702 transmitted by BSS1 may identify BSS2 as a co-located BSS that supports the ER format, and the CL_BSS indicator 704 transmitted by BSS2 may identify BSS1 as a co-located BSS that supports the non-ER format.

The wireless stations STA1 and STA2 may use the information provided in the CL_BSS indicators 702 and 704, respectively, to dynamically switch between the Basic Service Sets BSS1 and BSS2. In some implementations, an HE STA may associate with a different virtual BSS depending on its proximity to the AP 710 (or channel conditions) at any given time. With reference for example to the wireless system 700B of FIG. 7B, STA1 may eventually move beyond the standard wireless range 701 of the AP 710 and STA2 may eventually move within the standard wireless range 701. As a result of this movement, STA2 may now take advantage of the non-ER format and STA1 may now communicate with the AP 710 using the ER format. Among other advantages, aspects of the present disclosure may provide IP continuity, faster discovery, and faster reassociation when transitioning between co-located BSSs (compared to conventional techniques of transitioning between different BSSs).

In some implementations, STA1 may have identified BSS2 as a co-located BSS that supports the ER format, for example, based on the CL_BSS indicator 702 and other information included in the neighbor report transmitted by BSS1. Thus, STA1 may immediately send a reassociation (RA) request 706 to BSS2 when it moves beyond the standard wireless range 701 (without having to perform a scanning operation). Since STA1 may already have knowledge of most, if not all, of the capabilities, operating parameters, or configurations of BSS2 as well as the AP 710, the reassociation operation (between STA1 and BSS2) may be completed relatively quickly. Thus, any ongoing communications between the AP 710 (via BSS1) and STA1 may be resumed (via BSS2) with minimal delay.

In some implementations, STA2 may have identified BSS1 as a co-located BSS that supports the non-ER format, for example, based on the CL_BSS indicator 704 and other information included in the neighbor report transmitted by BSS2. Thus, STA2 may immediately send a reassociation request 708 to BSS1 when its preferred frame format changes (without having to perform a scanning operation). Since STA2 may already have knowledge of most, if not all, of the capabilities, operating parameters, or configurations of BSS1 as well as the AP 710, the reassociation operation (between STA2 and BSS1) may be completed relatively quickly. Thus, thus any ongoing communications between the AP 710 (via BSS2) and STA2 may be resumed (via BSS1) with minimal delay.

It is noted that virtual BSSs provided by the same physical AP may share a common set of hardware resources. Thus, each virtual BSS provided by the AP 710 also may share a set of common BSS parameters. For example, BSS1 may have one or more BSS parameters (such as a wireless channel or BSS color) in common with BSS2. As described with respect to FIGS. 1-6, aspects of the present disclosure may enable an HE AP to implement changes to one or more of its BSS parameters in a synchronized manner across different PHY formats. In the example of FIGS. 7A and 7B, the different PHY formats are provided by different Basic Service Sets BSS1 and BSS2. Thus, in some implementations, the Basic Service Sets BSS1 and BSS2 may coordinate changes to one or more common BSS parameters (such that the changes are implemented in a synchronized manner across the different PHY formats).

In some implementations, the Basic Service Sets BSS1 and BSS2 may be configured to implement a change in BSS at substantially the same time (such as described with respect to FIG. 4). With reference for example to FIG. 4, STA1 may move beyond the standard wireless range 701 of the AP 710 between times t₃ and t₄ and, as a result, may switch from BSS1 to BSS2. This results in a switch from the primary PHY format (the non-ER format) to the secondary PHY format (the ER format). Even though STA1 may no longer receive beacons at TBTTs associated with the first PHY format, STA1 may still implement the change in BSS at the target transition time (time t₄) based on ΔBSS announcement messages previously transmitted by the AP 710 in accordance with the first PHY format (on behalf of BSS1). Similarly, STA2 may move within the standard wireless range 701 of the AP 710 between times t₃ and t₄ and, as a result, may switch from BSS2 to BSS1. This results in a switch from the secondary PHY format (the ER format) to the primary PHY format (the non-ER format). Even though STA2 may not yet receive beacons at TBTTs associated with the first PHY format, STA2 may still implement the change in BSS at the target transition time (time t₄) based on ΔBSS announcement messages previously transmitted by the AP 710 in accordance with the second PHY format (on behalf of BSS2).

In some other implementations, the Basic Service Sets BSS1 and BSS2 may be configured to implement a change in BSS at different times (such as described with respect to FIG. 6). With reference for example to FIG. 6, STA1 may move beyond the standard wireless range 701 of the AP 710 after the BSS color change countdown has been initiated for the first PHY format (at time t₂) and, as a result, may switch from BSS1 to BSS2. This results in a switch from the primary PHY format (the non-ER format) to the secondary PHY format (the ER format). Since BSS color-related features are disabled during this time, STA1 may implement the new BSS color based on the countdown associated with the first PHY format (at time t₆) or the countdown associated with the second PHY format (at time t₇) without any discontinuity in service. Similarly, STA2 may move within the standard wireless range 701 of the AP 710 after the BSS color change countdown has been initiated for the second PHY format (at time t₃) and, as a result, may switch from BSS2 to BSS1. This results in a switch from the secondary PHY format (the ER format) to the primary PHY format (the non-ER format). Since BSS color-related features are disable during this time, STA2 may implement the new BSS color based on the countdown associated with the first PHY format (at time t₆) or the countdown associated with the second PHY format (at time t₇) without any discontinuity in service.

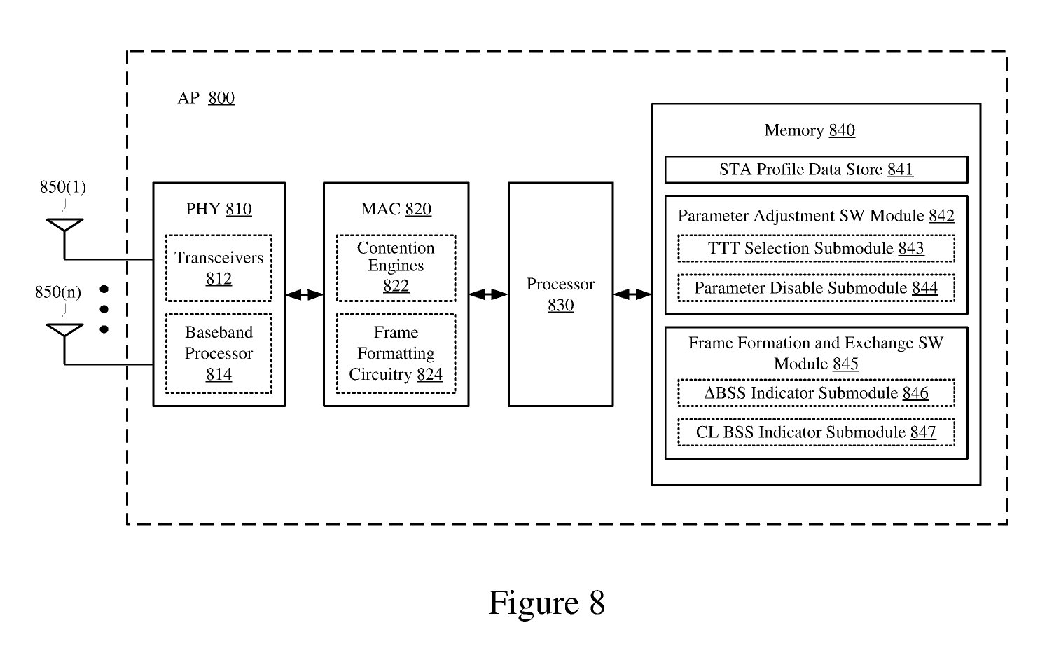

FIG. 8 shows a block diagram of an example access point (AP) 800. In some implementations, the AP 800 may be an HE AP that supports multiple PHY formats (such as the ER format and a non-ER format). For example, the AP 800 may be an example implementation of any of the APs 110, 310, or 710, respectively, of FIG. 1, FIG. 3, or FIGS. 7A and 7B. The AP 800 may include a PHY 810, a MAC 820, a processor 830, a memory 840, and a number of antennas 850(1)-850(n).

The PHY 810 may include a number of transceivers 812 and a baseband processor 814. The transceivers 812 may be coupled to the antennas 850(1)-850(n), either directly or through an antenna selection circuit (not shown for simplicity). The transceivers 812 may be used to communicate wirelessly with one or more STAs, with one or more APs, or with other suitable devices. The baseband processor 814 may be used to process signals received from the processor 830 or the memory 840 and to forward the processed signals to the transceivers 812 for transmission via one or more of the antennas 850(1)-850(n), and may be used to process signals received from one or more of the antennas 850(1)-850(n) via the transceivers 812 and to forward the processed signals to the processor 830 or the memory 840.

Although not shown in FIG. 8, for simplicity, the transceivers 812 may include any number of transmit chains to process and transmit signals to other wireless devices via the antennas 850(1)-850(n), and may include any number of receive chains to process signals received from the antennas 850(1)-850(n). Thus, in some implementations, the AP 800 may be configured for MIMO operations including, for example, single-user MIMO (SU-MIMO) operations and multi-user (MU-MIMO) operations. In addition, the AP 800 may be configured for OFDMA communications or other suitable multiple access mechanisms, for example, as may be specified by any of the IEEE 802.11 standards.

The MAC 820 may include at least a number of contention engines 822 and frame formatting circuitry 824. The contention engines 822 may contend for access to the shared wireless medium, and may store packets for transmission over the shared wireless medium. In some implementations, the contention engines 822 may be separate from the MAC 820. Still further, in some implementations, the contention engines 822 may be implemented as one or more software modules (stored in the memory 840 or in memory provided within the MAC 820). The frame formatting circuitry 824 may be used to create or format frames received from the processor 830 or the memory 840 (such as by adding MAC headers to PDUs provided by the processor 830), and may be used to re-format frames received from the PHY 810 (such as by stripping the MAC headers from frames received from the PHY 810).

The memory 840 may include a STA profile store 841 that stores profile information for a plurality of STAs. The profile information for a particular STA may include, for example, its MAC address, supported data rates, connection history with the AP 800, one or more resource units (RUs) allocated to the STA, and any other suitable information pertaining to or describing the operation of the STA.

The memory 840 also may include a non-transitory computer-readable medium (one or more nonvolatile memory elements, such as EPROM, EEPROM, Flash memory, a hard drive, and the like) that may store at least the following software (SW) modules:
a parameter adjustment SW module 842 to dynamically change one or more BSS parameters of the AP 800, the parameter adjustment SW module 842 including:
   a target transition time (TTT) selection submodule 843 to select a time at which the change in BSS parameters is to be implemented; and
   a parameter disable submodule 844 to temporarily disable one or more features related to the BSS parameters undergoing changes; and
a frame formation and exchange SW module 845 to facilitate the creation and exchange of communication frames in accordance with a plurality of PHY formats supported by the AP 800, the frame formation and exchange SW module 845 including:
   a change-in-BSS (ΔBSS) indicator submodule 846 to generate ΔBSS announcement messages indicating the change in BSS to one or more HE STAs in a vicinity of the AP 800; and
   a co-located (CL) BSS indicator submodule 847 to identify one or more co-located BSSs provided by the AP 800 and indicate a supported PHY format for each of the co-located BSSs.
      Each software module includes instructions that, when executed by the processor 830, cause the AP 800 to perform the corresponding functions.

For example, the processor 830 may execute the parameter adjustment SW module 842 to dynamically change one or more BSS parameters of the AP 800. In executing the parameter adjustment SW module 842, the processor 830 may further execute the TTT selection submodule 843 or the parameter disable submodule 844. For example, the processor 830 may execute the TTT selection submodule 843 to determine a time at which the change in BSS parameters are to be implemented. The processor 830 may execute the parameter disable submodule 844 to temporarily disable one or more features related to the BSS parameters undergoing changes.

The processor 830 also may execute the frame formation and exchange SW module 845 to facilitate the creation and exchange of communication frames in accordance with a plurality of PHY formats supported by the AP 800. In executing the frame formation and exchange SW module 845, the processor 830 may further execute the ΔBSS indicator submodule 846 or the CL BSS indicator submodule 847. For example, the processor may execute the ΔBSS indicator submodule 846 to generate ΔBSS announcement messages indicating the change in BSS to one or more HE STAs in a vicinity of the AP 800. The processor 830 may execute the CL BSS indicator submodule 847 to identify one or more co-located BSSs provided by the AP 800 and indicate a supported PHY format for each of the co-located BSSs.

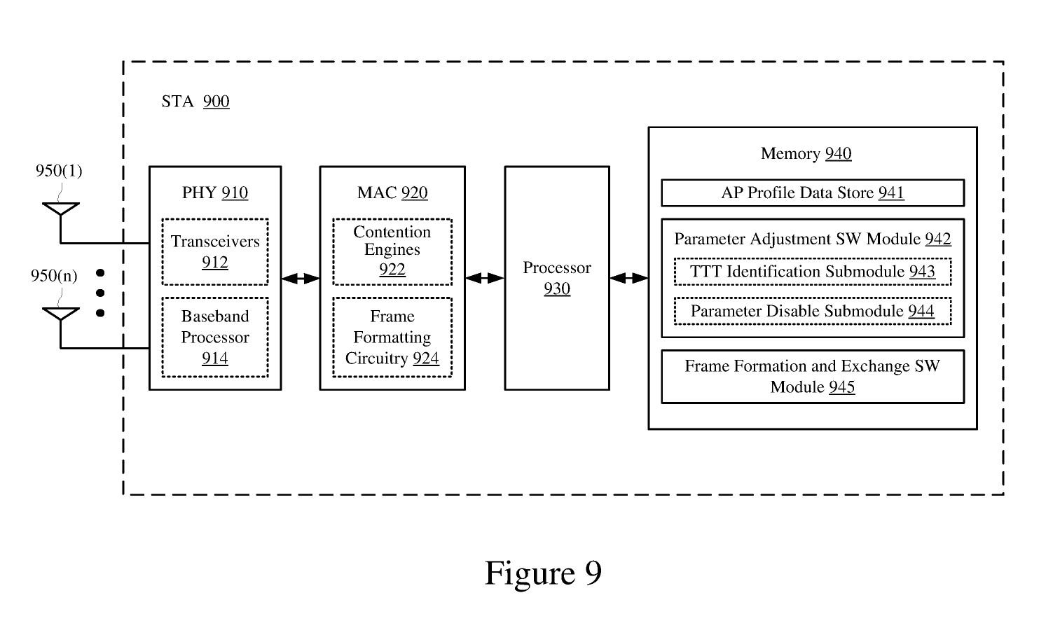

FIG. 9 shows a block diagram of an example wireless station (STA) 900. In some implementations, the STA 900 may be an HE STA that supports multiple PHY formats (such as the ER format and a non-ER format). For example, the STA 900 may be an example implementation of any of the wireless stations STA1 or STA2 of FIG. 1, FIG. 3, or FIGS. 7A and 7B. The STA 900 may include a PHY 910, a MAC 920, a processor 930, a memory 940, and a number of antennas 950(1)-950(n).

The PHY 910 may include a number of transceivers 912 and a baseband processor 914. The transceivers 912 may be coupled to the antennas 950(1)-950(n), either directly or through an antenna selection circuit (not shown for simplicity). The transceivers 912 may be used to communicate wirelessly with one or more APs, with one or more STAs, or with other suitable devices. The baseband processor 914 may be used to process signals received from the processor 930 or the memory 940 and to forward the processed signals to the transceivers 912 for transmission via one or more of the antennas 950(1)-950(n), and may be used to process signals received from one or more of the antennas 950(1)-950(n) via the transceivers 912 and to forward the processed signals to the processor 930 or the memory 940.

Although not shown in FIG. 9, for simplicity, the transceivers 912 may include any number of transmit chains to process and transmit signals to other wireless devices via the antennas 950(1)-950(n), and may include any number of receive chains to process signals received from the antennas 950(1)-950(n). Thus, in some implementations, the STA 900 may be configured for MIMO operations including, for example, single-user MIMO (SU-MIMO) operations and multi-user (MU-MIMO) operations. In addition, the STA 900 may be configured for OFDMA communications or other suitable multiple access mechanisms, for example, as may be specified by any of the IEEE 802.11 standards.

The MAC 920 may include at least a number of contention engines 922 and frame formatting circuitry 924. The contention engines 922 may contend for access to the shared wireless medium, and may store packets for transmission over the shared wireless medium. In some implementations, the contention engines 922 may be separate from the MAC 920. Still further, in some implementations, the contention engines 922 may be implemented as one or more software modules (stored in the memory 940 or in memory provided within the MAC 920). The frame formatting circuitry 924 may be used to create or format frames received from the processor 930 or the memory 940 (such as by adding MAC headers to PDUs provided by the processor 930), and may be used to re-format frames received from the PHY 910 (such as by stripping the MAC headers from frames received from the PHY 910).

The memory 940 may include an AP profile data store 941 that stores profile information for a plurality of BSSs. The profile information for a particular BSS may include, for example, the BSSID, MAC address, channel information, received signal strength indicator (RSSI) values, goodput values, channel state information (CSI), supported data rates, connection history with the BSS, a trustworthiness value of the BSS (indicating a level of confidence about the BSS's location or other properties associated with the BSS), and any other suitable information pertaining to or describing the operation of the BSS.

The memory 940 also may include a non-transitory computer-readable medium (one or more nonvolatile memory elements, such as EPROM, EEPROM, Flash memory, a hard drive, and the like) that may store at least the following software (SW) modules:
a parameter adjustment SW module 942 to change one or more BSS parameters of the STA 900, the parameter adjustment SW module 942 including:
   a target transition time (TTT) identification submodule 943 to determine a time at which the change in BSS parameters is to be implemented; and
a parameter disable submodule 944 to temporarily disable one or more features related to the BSS parameters undergoing changes; and
a frame formation and exchange SW module 945 to facilitate the creation and exchange of communication frames in accordance with the various PHY formats supported by the STA 900.
   Each software module includes instructions that, when executed by the processor 930, cause the STA 900 to perform the corresponding functions.

For example, the processor 930 may execute the parameter adjustment SW module 942 to change one or more BSS parameters of the STA 900. In executing the parameter adjustment SW module 942, the processor 930 may further execute the TTT identification submodule 943 or the parameter disable submodule 944. For example, the processor 930 may execute the TTT identification submodule 943 to determine a time at which the change in BSS parameters is to be implemented. The processor 930 may execute the parameter disable submodule 944 to temporarily disable one or more features related to the BSS parameters undergoing changes. Still further, the processor 930 may execute the frame formation and exchange SW module 945 to facilitate the creation and exchange of communication frames in accordance with the various PHY formats supported by the STA 900.

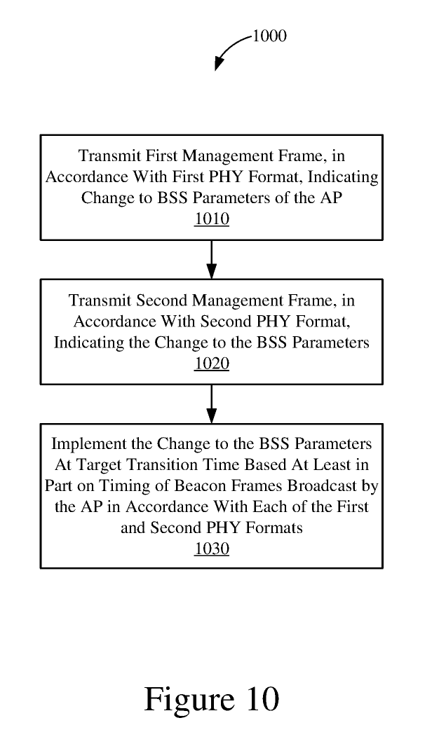

FIG. 10 shows a flowchart depicting an example operation 1000 for changing a BSS parameter of an AP that supports multiple PHY formats. The operation 1000 may be performed by a wireless device capable of communicating in accordance with multiple PHY formats such as, for example, the AP 110 of FIG. 1, the AP 310 of FIG. 3, or the AP 710 of FIGS. 7A and 7B. With reference for example to FIG. 1, the operation 1000 may be performed by the AP 110 to implement changes to one or more BSS parameters in a synchronized manner across the different PHY formats supported by the AP 110.

The AP may transmit a first management frame, in accordance with a first PHY format, indicating a change to one or more BSS parameters (1010). For example, the one or more BSS parameters may include a wireless channel or BSS color of the AP. With reference for example to FIG. 3, the first PHY format may correspond to a non-ER format that may perform better (than the ER format) when communicating with STAs that are within the standard wireless range 301 of the AP 310. The AP may broadcast beacon frames, in accordance with the first PHY format, at particular TBTTs assigned to the first PHY format (such as TBTT1 of FIG. 4). In some implementations, the first management frame may include a change-in-BSS (ΔBSS) announcement message (such as the BSS color change announcement element 500 of FIG. 5) indicating the new BSS parameters and a target transition time at which the new BSS parameters are to be implemented.

The AP may transmit a second management frame, in accordance with a second PHY format, indicating a change to one or more BSS parameters (1020). For example, the one or more BSS parameters may include a wireless channel or BSS color of the AP. With reference for example to FIG. 3, the second PHY format may correspond to an ER format that may perform better (than the non-ER format) when communicating with STAs that are beyond the standard wireless range 301 of the AP 310. The AP may broadcast beacon frames, in accordance with the second PHY format, at particular TBTTs assigned to the second PHY format (such as TBTT2 of FIG. 4). In some implementations, the second management frame may include a ΔBSS announcement message (such as the BSS color change announcement element 500 of FIG. 5) indicating the new BSS parameters and a target transition time at which the new BSS parameters are to be implemented.

The AP may implement the change to the one or more BSS parameters at the target transition time based, at least in part, on a timing of beacon frames broadcast by the AP in accordance with each of the first and second PHY formats (1030). For example, the target transition time may coincide with a time at which some (if not all) of the associated STAs are awake and listening for communications from the AP (such as a TBTT). However, in some implementations, TBTTs of the first PHY format may be different than TBTTs of the second PHY format. Thus, the AP may coordinate the change in BSS based on a relative timing of beacon frames transmitted in accordance with each of the first and second PHY formats. In some implementations, the change in BSS may coincide with a particular TBTT of the first PHY format or the second PHY format. With reference for example to FIG. 4, the change in BSS may occur at a target transition time that is aligned with a TBTT of the first PHY format. In some other implementations, the change in BSS may not coincide with any of the first TBTTs or the second TBTTs. With reference for example to FIG. 6, the change in BSS may occur at any time during a target transition period between a TBTT of the first PHY format and a TBTT of the second PHY format.

In some implementations, where the change in BSS coincides with a TBTT of a particular PHY format, the AP may provide information in another PHY format pointing to the TBTT associated with the selected PHY format. With reference for example to FIG. 4, the ΔBSS announcement messages transmitted in accordance with the second PHY format may include timing information pointing to one or more TBTTs of the first PHY format (such as a timing of the next TBTT of the first PHY format or a relative offset between TBTTs of the first PHY format and TBTTs of the second PHY format). In some other implementations, STAs operating in accordance with different PHY formats may implement the change in BSS according to their respective TBTTs. With reference for example to FIG. 6, the AP may temporarily disable selected BSS features (such as a BSS color check procedure) to provide uninterrupted service to its associated STAs while the STAs implement the changes to the one or more BSS parameters at different times. The AP may subsequently re-enable the selected BSS features once the change in BSS has been successfully implemented by each of its associated STAs.

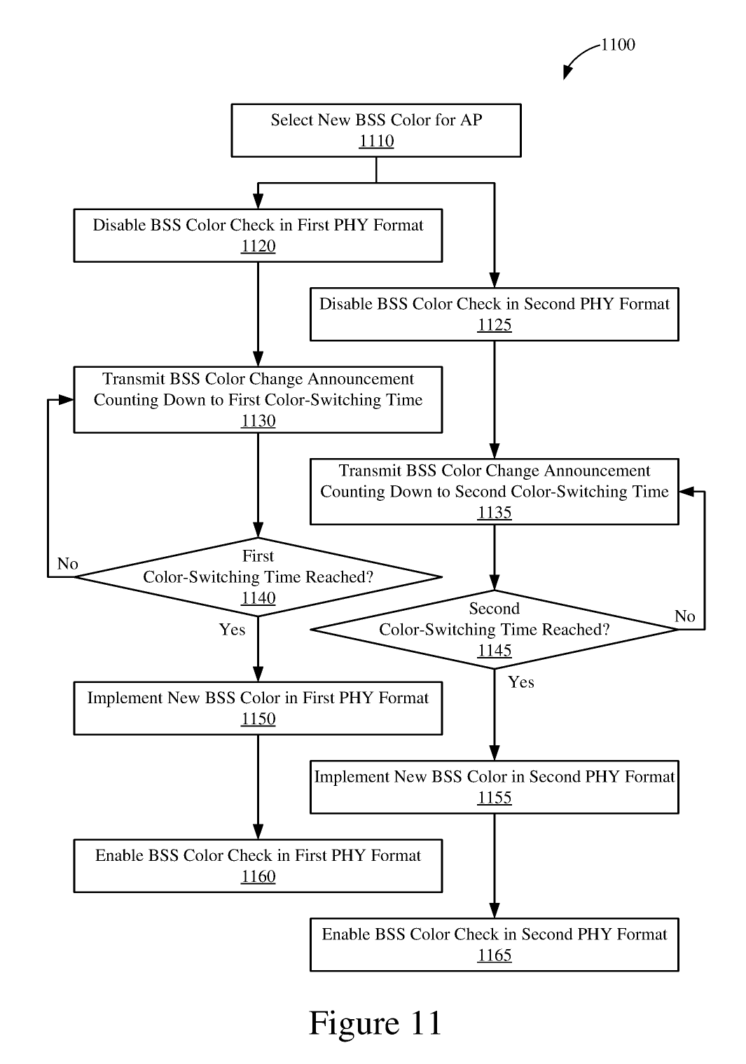

FIG. 11 shows a flowchart depicting an example operation 1100 for changing the BSS color of an AP that supports multiple PHY formats. The operation 1100 may be performed by a wireless device capable of communicating in accordance with multiple PHY formats such as, for example, the AP 110 of FIG. 1, the AP 310 of FIG. 3, or the AP 710 of FIGS. 7A and 7B. With reference for example to FIG. 1, the operation 1100 may be performed by the AP 110 to change the BSS color of one or more of its BSSs at different times for the different PHY formats supported by the AP 110.

The AP may first select a new BSS color to be implemented for one or more of its BSSs (1110). For example, the AP may detect that a neighboring or overlapping BSS has the same BSS color as the AP's current BSS color. To avoid BSS color collisions, the AP may select a new BSS color for its associated BSS(s). In some implementations, the AP may operate as a single BSS that supports multiple PHY formats. For example, the BSS may support dual beacon operation. Thus, the BSS color of the AP may apply to each of the different PHY formats. In some other implementations, the AP may operate as a plurality of virtual BSSs. For example, each PHY format supported by the AP may be provided by a different virtual BSS. Thus, each virtual BSSs of the AP may have the same BSS color.

Prior to implementing the change in BSS color, the AP may disable a BSS color check procedure for the first PHY format (1120) and may disable a BSS color check procedure for the second PHY format (1125). For example, the AP may disable the BSS color check procedure using the HE Operation element (such as by storing a value of 1 in the BSS Color Disabled subfield 244 of the HE Operation element 200 shown in FIG. 2) of beacon or other management frames transmitted in accordance with each of the first and second PHY formats. With the BSS color check operation disabled, HE devices (including the AP and its associated STAs) may ignore the BSS color of incoming communication frames. As a result, the HE devices will not filter or discard any incoming communication frames on the basis of their BSS color.

With the BSS color check procedure disabled for the first PHY format, the AP may transmit a BSS color change announcement counting down to a first color-switching time (1130). With reference for example to FIG. 5, the BSS color change announcement may be signaled via a BSS color change announcement element 500 provided in beacon or other management frames transmitted by the AP. The BSS color change announcement element 500 may identify the new BSS color (in the New Color Information field 550) that is scheduled to take effect at the first color-switching time, as well as a countdown to the first color-switching time (in the Color Switch Countdown field 540). In some implementations, the first color-switching time may coincide with a subsequent TBTT of the first PHY format. Thus, at each subsequent TBTT of the first PHY format, the AP may determine whether the first color-switching time has been reached (1140). As long as the first color-switching time has not been reached (as tested at 1140), the AP may continue to transmit BSS color change announcements, in the first PHY format, with an updated countdown timer (1130).

With the BSS color check procedure disabled for the second PHY format, the AP may transmit a BSS color change announcement counting down to a second color-switching time (1135). With reference for example to FIG. 5, the BSS color change announcement may be signaled via a BSS color change announcement element 500 provided in beacon or other management frames transmitted by the AP. The BSS color change announcement element 500 may identify the new BSS color (in the New Color information field 550) that is scheduled to take effect at the second color-switching time, as well as a countdown to the second color-switching time (in the Color Switch Countdown field 540). In some implementations, the second color-switching time may coincide with a subsequent TBTT of the second PHY format. Thus, at each subsequent TBTT of the second PHY format, the AP may determine whether the second color-switching time has been reached (1145). As long as the second color-switching time has not been reached (as tested at 1145), the AP may continue to transmit BSS color change announcements, in the second PHY format, with an updated countdown timer (1135).

When the first color-switching time has been reached (as tested at 1140), the AP may implement the new BSS color in the first PHY format (1150). For example, the AP may instruct any STAs operating in accordance with the first PHY format to switch to the new BSS color by transmitting a BSS color change announcement, in the first PHY format, with an updated countdown indicating that the new BSS color is to take effect at this time. When the second color-switching time has been reached (as tested at 1145), the AP may implement the new BSS color in the second PHY format (1155). For example, the AP may instruct any STAs operating in accordance with the second PHY format to switch to the new BSS color by transmitting a BSS color change announcement, in the second PHY format, with an updated countdown indicating that the new BSS color is to take effect at this time. In some implementations, the AP may implement the new BSS color for outgoing communication frames at any time between the first color-switching time and the second color-switching time (inclusive). For example, since the BSS color-related features are still disabled at this time, the AP may continue to communicate with its associated STAs in each of the first and second PHY formats even though some of the STAs may have switched to the new BSS color while other STAs may still recognize the old BSS color.

After the new BSS color has been implemented in each of the first and second PHY formats, the AP may enable (or re-enable) the BSS color check procedure in the first PHY format (1160) and may further enable (or re-enable) the BSS color check procedure in the second PHY format (1165). For example, the AP may re-enable the BSS color check procedure using the HE Operation element (such as by storing a value of 0 in the BSS Color Disabled subfield 244 of the HE Operation element 200 shown in FIG. 2) of beacon or other management frames transmitted in accordance with each of the first and second PHY formats. With the BSS color check operation enabled, HE devices (including the AP and its associated STAs) may resume filtering communication frames on the basis of their BSS color.

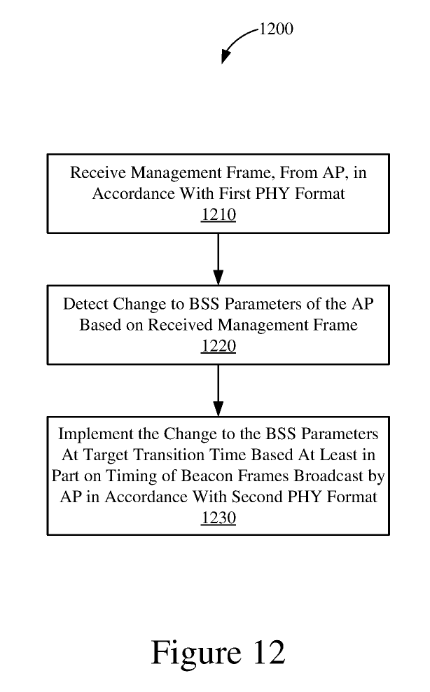

FIG. 12 shows a flowchart depicting an example operation 1200 for implementing a change to a BSS parameter of an AP that supports multiple PHY formats. The operation 1200 may be performed by an HE STA such as, for example, wireless stations STA1 or STA2 of FIG. 1, FIG. 3, or FIGS. 7A and 7B. With reference for example to FIG. 1, the operation 1200 may be performed by any of the wireless stations STA1 or STA2 to implement changes to one or more BSS parameters of the AP 110.

The STA may receive a management frame, from the AP, in accordance with a first PHY format (1210). For example, the AP may support communications in a plurality of different PHY formats, including at least a first PHY format and a second PHY format. In some implementations, the STA may receive the management frame at a TBTT associated with the first PHY format. More specifically, TBTTs of the first PHY format may not coincide with TBTTs of the second PHY format.

The STA detects a change to one or more BSS parameters of the AP based on the received management frame (1220). For example, the one or more BSS parameters may include a wireless channel or BSS color of the AP. In some implementations, the management frame may include a change-in-BSS (ΔBSS) announcement message (such as the BSS color change announcement element 500 of FIG. 5) indicating the new BSS parameters and a target transition time at which the new BSS parameters are to be implemented.

The STA may implement the change to the one or more BSS parameters at the target transition time based at least in part on a timing of beacon frames broadcast by the AP in accordance with the second PHY format (1230). In some implementations, the target transition time may coincide with a TBTT of the second PHY format. Thus, the ΔBSS announcement message of the received management frame may include timing information pointing to one or more TBTTs of the second PHY format (such as a timing of the next TBTT of the second PHY format or a relative offset between TBTTs of the first PHY format and TBTTs of the second PHY format). In some other implementations, the target transition time may occur at any time within a period between a TBTT of the first PHY format and a TBTT of the second PHY format. In some aspects, the STA may temporarily disable selected BSS features (such as a BSS color check procedure) prior to the target transition period to ensure uninterrupted service with the associated AP while implementing the change to the one or more BSS parameters. The STA may subsequently re-enable the selected BSS features once a threshold duration has elapsed since the end of the target transition period.

As used herein, a phrase referring to “at least one of” a list of items refers to any combination of those items, including single members. As an example, “at least one of: a, b, or c” is intended to cover: a, b, c, a-b, a-c, b-c, and a-b-c.

The term “wireless station” or “STA,” as used herein, also may refer to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method, comprising:
transmitting a first management frame indicating a change to a basic service set (BSS) parameter of an access point (AP), wherein the first management frame is formatted in accordance with a first physical layer (PHY) format;
transmitting a second management frame indicating the change to the BSS parameter, wherein the second management frame is formatted in accordance with a second PHY format; and
implementing the change to the BSS parameter at a target transition time based at least in part on a timing of beacon frames broadcast by the AP in accordance with each of the first and second PHY formats.

2. The method of claim 1, wherein one of the first or second PHY formats is an extended range (ER) format.

3. The method of claim 1, wherein each of the first and second management frames includes information indicating the target transition time.

4. The method of claim 3, wherein the target transition time coincides with a target beacon transmission time (TBTT) associated with the first PHY format.

5. The method of claim 3, wherein the information in the second management frame indicates a timing offset between the target transition time and a TBTT associated with the second PHY format.

6. The method of claim 3, wherein the information in the second management frame indicates a timing of TBTTs associated with the first PHY format.

7. The method of claim 3, wherein the target transition time overlaps a first TBTT associated with the first PHY format and a second TBTT associated with the second PHY format.

8. The method of claim 7, wherein the information in the first management frame indicates the first TBTT as the target transition time and the information in the second management frame indicates the second TBTT as the target transition time.

9. The method of claim 7, wherein the information in the first management frame includes a countdown to the first TBTT and the information in the second management frame includes a countdown to the second TBTT.

10. The method of claim 1, wherein the BSS parameter includes a BSS color, and wherein the implementing comprises:
disabling a BSS color check procedure for a period of time prior to the target transition time;
implementing the change in BSS color during the period of time for which the BSS color check procedure is disabled; and
re-enabling the BSS color check procedure after the change in BSS color has been implemented.

11. The method of claim 1, wherein the first management frame is transmitted on behalf of a first BSS associated with the AP and the second management frame is transmitted on behalf of a second BSS associated with the AP, and wherein the BSS parameter is shared by the first BSS and the second BSS.

12. The method of claim 11, wherein at least one of the first or second management frames includes a neighbor report identifying the first and second BSSs as co-located BSSs.

13. A wireless device, comprising:
one or more processors; and
a memory storing instructions that, when executed by the one or more processors, cause the wireless device to:
transmit a first management frame indicating a change to a basic service set (BSS) parameter of the wireless device, wherein the first management frame is formatted in accordance with a first physical layer (PHY) format;
transmit a second management frame indicating the change to the BSS parameter, wherein the second management frame is formatted in accordance with a second PHY format; and
implement the change to the BSS parameter at a target transition time based at least in part on a timing of beacon frames broadcast by the wireless device in accordance with each of the first and second PHY formats.

14. The wireless device of claim 13, wherein each of the first and second management frames includes information indicating the target transition time.

15. The wireless device of claim 14, wherein the target transition time coincides with a target beacon transmission time (TBTT) associated with the first PHY format, and wherein the information in the second management frame indicates a timing offset between the target transition time and a TBTT associated with the second PHY format.

16. The wireless device of claim 14, wherein the target transition time coincides with a TBTT associated with the first PHY format, and wherein the information in the second management frame indicates a timing of TBTTs associated with the first PHY format.

17. The wireless device of claim 14, wherein the target transition time overlaps a first TBTT associated with the first PHY format and a second TBTT associated with the second PHY format, and wherein the information in the first management frame indicates the first TBTT as the target transition time and the information in the second management frame indicates the second TBTT as the target transition time.

18. The wireless device of claim 14, wherein the target transition time overlaps a first TBTT associated with the first PHY format and a second TBTT associated with the second PHY format, and wherein the information in the first management frame includes a countdown to the first TBTT and the information in the second management frame includes a countdown to the second TBTT.

19. The wireless device of claim 13, wherein the BSS parameter includes a BSS color, and wherein execution of the instructions for implementing the change to the BSS parameter causes the wireless device to:
disable a BSS color check procedure for a period of time prior to the target transition time;
implement the change in BSS color during the period of time for which the BSS color check procedure is disabled; and
re-enable the BSS color check procedure after the change in BSS color has been implemented.

20. The wireless device of claim 13, wherein the first management frame is transmitted on behalf of a first BSS associated with the wireless device and the second management frame is transmitted on behalf of a second BSS associated with the wireless device, and wherein the BSS parameter is shared by the first BSS and the second BSS.

21. A method, comprising:
receiving a management frame from an access point (AP), wherein the management frame is formatted in accordance with a first physical layer (PHY) format;
detecting a change to a basic service set (BSS) parameter of the AP based on the received management frame; and
implementing the change to the BSS parameter at a target transition time based at least in part on a timing of beacon frames broadcast by the AP in accordance with a second PHY format.

22. The method of claim 21, wherein the target transition time coincides with a target beacon transmission time (TBTT) associated with the second PHY format, and wherein the management frame indicates a timing offset between the target transition time and a TBTT associated with the first PHY format.

23. The method of claim 21, wherein the target transition time coincides with a TBTT associated with the second PHY format, and wherein the management frame indicates a timing of TBTTs associated with the second PHY format.

24. The method of claim 21, wherein the target transition time overlaps a first TBTT associated with the first PHY format and a second TBTT associated with the second PHY format, and wherein the management frame indicates the first TBTT as the target transition time.

25. The method of claim 21, wherein the target transition time overlaps a first TBTT associated with the first PHY format and a second TBTT associated with the second PHY format, and wherein the management frame includes a countdown to the first TBTT.

26. A wireless device, comprising:
one or more processors; and
a memory storing instructions that, when executed by the one or more processors, cause the wireless device to:
receive a management frame from an access point (AP), wherein the management frame is formatted in accordance with a first physical layer (PHY) format;
detect a change to a basic service set (BSS) parameter of the AP based on the received management frame; and
implement the change to the BSS parameter at a target transition time based at least in part on a timing of beacon frames broadcast by the AP in accordance with a second PHY format.

27. The wireless device of claim 26, wherein the target transition time coincides with a target beacon transmission time (TBTT) associated with the second PHY format, and wherein the management frame indicates a timing offset between the target transition time and a TBTT associated with the first PHY format.

28. The wireless device of claim 26, wherein the target transition time coincides with a TBTT associated with the second PHY format, and wherein the management frame indicates a timing of TBTTs associated with the second PHY format.

29. The wireless device of claim 26, wherein the target transition time overlaps a first TBTT associated with the first PHY format and a second TBTT associated with the second PHY format, and wherein the management frame indicates the first TBTT as the target transition time.

30. The wireless device of claim 26, wherein the target transition time overlaps a first TBTT associated with the first PHY format and a second TBTT associated with the second PHY format, and wherein the management frame includes a countdown to the first TBTT.
